(19) United States
(12) Patent Application Publication
(10) Pub. No.: US 2006/0102007 A1
(43) Pub. Date: May 18, 2006

(54) Cold Bubble Distillation Method and Device

(76) Inventor: David Martin, Santa Barbara, CA (US)

Correspondence Address: LAURA N. TUNNELL, P.O. BOX 91929, SANTA BARBARA, CA, 93190, US

(21) Appl. No.: 10/908,458

(22) Filed: May 12, 2005

Related U.S. Application Data
(60) Provisional application No. 60/627,149, filed on Nov. 15, 2004.

(51) Int. Cl. A23L 1/00

(52) U.S. Cl. 99/275

(57) ABSTRACT

A cold method of heated distillation by manipulating bubbles, and cold distillate condensation is described. The continuous method introduces counter-current gas bubbles to a solution under vacuum at cold temperatures, using passive bubble manipulation. This approach accomplishes volatile evaporation at temperatures too low for thermal damage to occur, scrubs distilland mist from evaporated distillate, and condenses distillate by adding little or no heat. The method operates between freezing and ambient temperatures, but primarily near freezing, thus reducing energy consumption, and completely avoiding common thermal damage to delicate aroma, flavor, color, and nutritional distillate constituents that are characteristic of conventional aroma or essence extraction, food or drink concentrations, and chemical separation processes.

This invention relates to distillation or stripping columns (gas-liquid contacting columns), and is in the category of mass-transfer devices such as packed, plate, bubble-cap, spinning cone columns, and other counter-current evaporation devices. It relates more particularly to essence extraction, concentration of various food liquids, and chemical separation, and creates a unique category of cold distillation for cold concentration, and an option for freeze condensation.

### BACKGROUND OF THE INVENTION

Technologies: Older volatile-stripping or liquid-gas contacting technology, such as packed columns, falling film evaporators, sieve tray or bubble cap tray columns, and tubular or plate juice evaporators all operate at elevated temperatures that involve extensive thermal abuse of the resultant food products. These methods require excessive heat, and tend to be optimized for a single product type. Newer and more versatile stripping methods, usually employing vacuum evaporation, such as the variety of agitated thin film evaporators and types of spinning cone columns, are more versatile and can operate at lower temperatures. Unfortunately, while these newer methods use lower operating temperatures, they still involve significant thermal damage to critical sensitive liquids such as delicate essence extractions and juice concentrates, and they involve new mechanical complexities such as internal precision moving parts, vacuum-tight food-grade shaft seals rotating in pools of food grade liquid, and sophisticated drive systems; all not present in older technologies. While these expensive mechanical complexities provide reduced heat damage, they still require application of heat at temperatures that are significantly destructive to flavor and nutrition in food products. While there is one non-evaporation concentrate technology called supercritical extraction, or freeze concentrating, that permits recovery of very high quality aroma, it is not a legitimate choice for almost every application. This is because the high capital and high operating costs, as well as the batch nature of this technique, limit its use to only production of compounds with a very high added value. We see then, that food crops worldwide have critical flavor and nutritional constituents routinely destroyed by every distillation method, since they all depend upon heating of the processed liquid to elevated product-destructive temperatures, and there are no viable production alternatives.

There is clearly a worldwide need for a simpler continuous distillation method that operates at temperatures that do not destroy the critical flavor and nutritional constituents of the products being processed. One of the primary products for this type of technology is fruit and vegetable juices of all types.

Worldwide Nutrition Loss: An increasing number of human health problems are being attributed to a gradual depletion of essential nutrition in modern foods. Consumers, and thus food brokers buy foods that simply look good, so most crop developments are for robust products that ship well, to look better when they reach the grocer's shelf, but not to have better flavor or nutrition. Since flavor often occurs naturally in foods proportional to the nutrition, food flavor is often an easily detectable indicator of high (or low) nutrition, and so we are biologically predisposed to choose foods based on flavor. Food packaging and preparation methods now commonly use low cost “taste impact” ingredients as substitutes for missing genuine flavor and nutrition, to give consumers an illusion of taste and product worth. This approach leaves consumers with a false impression that they are getting quality foods, even as legitimate flavor and nutrition in foods have been reduced to alarmingly low levels. Examples of low cost “taste impact” ingredients are sugars, high fructose sugars, salt, hot spices, and saturated oils. Worldwide diminution of inherent flavor and nutrition in common foods is causing health problems, and creating an urgent need for new foods and new food ingredients that can provide the missing nutrition and inherent flavor previously found in our everyday foods. A large and growing market for legitimate high flavor/high nutrition food products and ingredients already exists, as demonstrated by the booming demand for Natural Foods, functional foods, and nutriceuticals. These markets will accelerate their current rapid growth, as awareness of poor flavor and nutrition in conventional foods grows, but what these new high flavor/high nutrition products might be, and where they will come from, is an open question. There is now widespread recognition that the high temperatures commonly used to process food has also destroyed flavor and nutrition. This has stimulated a broad effort to reduce processing temperatures, but old technologies have all reached their limits, for additional heat reduction. Completely new methods are now required to reduce food-processing temperatures further. Especially needed and valuable, will be any processes operating at near-freezing temperatures.

Nature's Low Temperature Example: Plants that yield the produce we use for juice have evolved over millions of years, and throughout the evolution millennia, these plants always produced the living vegetable or fruit within a narrow “living plant” temperature range. Most fruits for example, have natural pigments, oils, or natural opacity features that block damaging sun radiation, such as UV-blocking dark colored grape skins, or all types of nutshells for example. Most fruit juice plant varieties have also evolved mechanisms for keeping their fruit several degrees cooler than the ambient temperature in hot weather conditions. In most cases for example, the fruit grows under the shade of breeze-cooled layers of leaves, which is a much cooler location than full sun exposure. Many fruits are round, or a variation of round. The round shape allows some of the fruit (the upper portion), to shade most of the fruit from direct sun, and efficiently retain any nighttime coolness in the fruit, during temperature spikes at the hottest part of the day. Some fruits have natural thermal insulation, like the outer layer of coconuts, and the white pulpy Albedo layer in the skin of all oranges. That orange insulation layer is also usually thicker on top, where it gets direct sun exposure at the hottest part of the day, when the sun is highest in the sky.

One result of the fruit's natural cooling solutions, such as those described above, is that the plant protects its fruit from excessive heat by lowering fruit temperature several degrees when exposed to higher temperatures. Any process that stays within the fruit's living temperature range, is operating at the naturally evolved “design-temperature” for the fruit, and will not thermally destroy the fruit's flavor or nutrition. If food processors can comply with this simple fact of nature—that is, if processing temperatures can be kept within the actual living plant's temperature range—processors will receive a natural benefit: heat-inflicted damage to the juice will be prevented. For most commercial fruits, the living fruit temperature range is between freezing and plant-shaded ambient high temperature.

The subject invention, the Cold Bubble Volatile Stripping process, prevents heat-inflicted damage to food liquids by operating entirely within a living plant's temperature range. Most of the processing time occurs near the freezing temperature of the liquid, and does not exceed temperatures of about 85 F degrees. The entire process is much colder than all other essence extraction or juice concentrate technologies, and does not inflict heat damage to the flavor and nutritional constituents of the initial fresh extracted juice or other plant liquids being processed.

Flavor and Aroma Extracts: Only five characteristics of flavor may be attributed to the sense of taste: sweet, sour, salty, bitter, and more recently there seems to be evidence of a “savory” taste experience as well. It is well known that substantially more than 90% of perceived flavor experiences are actually aroma experiences. The highest value aroma (and thus flavor) extracts are those that still retain the complex and fragile “lighter” top-note molecules intact. All aroma molecules are easily damaged by heat, but the most volatile and most fragile top-note molecules are the most easily destroyed by heat, and thus the first to experience thermal damage. Even modest thermal excursions are highly destructive to these complex top-note compounds.

Any reduction in processing temperatures will reduce flavor destruction. The distillation process has been used in the flavor industry for centuries, and is still the principle method of aroma extraction. Typical vacuum distillation is performed at lower temperatures than atmospheric distillation, and the lower temperatures that can be used with vacuum distillation, do result in somewhat better quality. The spinning cone column obtains perhaps the best quality commercial products among conventional methods. This technology usually employs lower temperatures than other vacuum distillation methods, but the processed material is still subjected to temperatures that destroy substantial flavor, especially among the highest value top-notes.

The spinning cone column requires that the processed incoming liquid be pre-heated enough so that the liquid can progress completely through the column before the liquid gets too cold, as there is no internal heating capability. The liquid is rapidly chilled through evaporation as it progresses downward through the column. If the liquid is not pre-heated enough, it may get too cold to provide efficient evaporation, or it could even begin to freeze up in the column, causing flow blockage and difficult cleanout problems. A method of supplementary heating, by removal/reheat/reinjection of the liquid midway through the column, is shown in the patent, and can be practiced to prevent freezing within the column. Flavor and nutritional damage from processing in a spinning cone column, is primarily caused at the external heating stage or stages. This damage cannot be removed by the column process itself, since the damage was done during preheating, before the liquid got into the column. The total time any liquid spends flowing down and being stripped within a spinning cone column, is very brief. Consequently, aroma-damaging external heating temperatures must often be used, in order to get any kind of efficiencies out of the liquid's brief pass through the column.

Turning to low temperature distilled flavor extracts, such as those used by flavor producers for orange extractions for example, we will find that while some heat damage is inflicted during evaporation, substantial damage occurs to the aromatic molecules as they pass through the dry screw vacuum pump at very high speed, where depending on the size of the pump, temperatures reach 250 F to 500 F, to as much as 700 F degrees for a brief time. Even this extremely brief high temperature exposure at molecule-wrenching high speeds through the vacuum pump, has been found to destroys substantial amounts of the very fragile aroma components, and especially to the top notes. Current hopes for reducing damage from this method are being placed on lower temperature pumps having variable pitch screws.

Juice Concentrates: Juice concentrates have always had huge potential, since concentrates can be frozen for long periods of time without degrading, and concentrates reduce shipping costs by removing most of the water beforehand. Unfortunately, all current methods for making concentrates create another problem: they use high-temperature evaporation methods, which destroy most of the flavor and nutrition that started out in the unconcentrated product. Because of this, conventional juice concentrates, for example, are of poor quality compared to fresh juice, and are not legitimate high flavor/high nutrition contenders.

The single great offense committed by all conventional juice processing technologies, is wholesale destruction of the complex delicate flavor and nutrition molecules that should be preserved and delivered to nutrition-starved people worldwide. In the beginning of the development of successful juice concentrate methods, the severely damaged juice concentrate was unpalatable—and unmarketable—to consumers. Only by employing a simple trick on the consumer, was customer acceptance finally accomplished: It was discovered that blending about 10% fresh juice into the concentrate, was enough to deceive the consumer's sense of taste into accepting reconstituted juice concentrate, as “close enough” to legitimate fresh squeezed juice. In a refinement of that trick on the palate, fruit essence (the multiple complex aroma and flavor volatile constituents of fresh juice responsible for taste), is currently used to replace some or all of the previously 10% fresh juice used to disguise widespread destruction of flavor attributes in the concentrate. Juice concentrate has always been a poor imitation of true fresh squeezed juice, but for almost sixty years, the public has accepted concentrate when fresh juice was unavailable, inconvenient, or too expensive.

Today, new consumer demand for more flavor and nutrition has created a whole new competitor for concentrates: the “Not from Concentrate” (NFC) juice. While advertising tries to create a perception that NFC is the same as fresh squeezed juice, a direct comparison with actual fresh squeezed juice will tell any consumer the disappointing truth. While NFC juice is a marked improvement over concentrate, it is lacking substantial flavor (and nutrition) that it started with as actual fresh squeezed juice. Its missing flavor and nutrition are destroyed by high temperature “Flash” Pasteurization, the process used to make all NFC juices. With Flash, the required high temperature is applied for the shortest possible duration of time, to achieve the required minimum level of NFC shelf stability. The resultant brief period of shelf stability involves high levels of loss on the store shelf, and in the consumers' refrigerator.

A still newer group of products attempting to satisfy this consumer demand for more flavor and nutrition are the so-called “Fresh Squeezed” juice products, such as those offered by Odawalla and Naked Juice. These products also employ the high temperature Flash process, but at higher temperatures and for an even shorter duration of time, to achieve an even briefer level of shelf stability. This variation of the Flash process does achieve less destruction of flavor and nutrition than either concentrates or NFC juices. But very high temperature is still applied to the juice, and significant destruction of flavor and nutrition also occurs to the so-called “Fresh Squeezed” juices. The level of pasteurization is so diminished and the shelf life is so reduced, that roughly 50% of these shelved products exceed their shelf life and are thrown away, before being sold. This extravagant wastefulness is paid for by the high price of the remaining products.

Why Concentrates Use High Temperature: There are reasons that processors use pasteurization temperatures in production of all juice concentrates, all NFC juices, and all of the so-called “fresh squeezed” juices. According to the FDA Final Rule on HACCP; Procedures for the Safe and Sanitary Processing and Importing of Juice: “ . . . pasteurization is the only widely adopted commercial technology for controlling pathogens in juice”. Therefore, the principle reasons to use high temperature are: [1]—pasteurization temperatures kill the food pathogens that must be destroyed to assure food safety. [2]—pasteurization temperatures inactivate naturally occurring enzymes that will otherwise degrade flavor. The third reason applies only to concentrates: [3]— High temperature is an integral consequence of all current methods of concentrating juice by vacuum evaporation.

Very effective pathogen kill and enzyme deactivation can be satisfied without high temperature. The simplest pathogen kill method is whole-fruit surface treatment, prior to juicing. There are also chemical and natural preservatives that can be added to finished concentrates or juices, and methods such as ultra-high pressure processing (UHPP or HPP). Unfortunately, without the present invention, there is no alternative to high temperatures for concentrating juice through evaporation. In the case of commercial juice concentrates, high heat is believed integral to the concentrate process of evaporating water. No other juice concentrate evaporation process can operate at the cold temperatures of the present invention, or can preserve the full flavor and nutrition originally present in the feedstock juice.

High-Temperature Heat Transfer: Concentration of liquids by vacuum-evaporation requires the input of a great deal of heat energy to the juice feedstock. But rather than using concentrated high-temperature heating, this invention uses a distributed low-temperature heating method. Other technologies demonstrate that juice heating and evaporation processes can be accelerated through applying higher temperature, by heating the juice rapidly with very hot devices having a large thermal differential compared to the juice. Such methods for rapid heating, such as pumping the juice stream into direct contact with a high temperature heat source (a high temperature heating element, or high temperature steam pipe or steam plate apparatus for example) are widely used. While this practice is simple and quick, it is very destructive to flavor and nutrition in delicate liquids such as juices.

The juice molecules that come into direct contact with the metal surface of a heating element for example, have their flavor/nutritional components completely destroyed by the intense heat, as these juice molecules are super-heated to temperatures far above the already too hot set-point temperature. These direct contact, first-heated molecules transfer heat energy to a successive number of adjacent cold molecules, in which all of the cold molecule's flavor/nutrition gets destroyed as the directly heated molecules cool down by transferring heat away to multiple adjacent cold molecules. Each of these heat-transferred flavor-destroyed molecules continues this heat transfer process to the next tier of cold molecules, transferring less heat and destroying less flavor/nutrition. This destructive cooling down process continues on, molecule-by-molecule, until typically, the juice reaches a blended equilibrium at a still high, and destructive, set-point temperature. In this example, the pre-heated juice is ready to be pumped into a conventional juice evaporation chamber, such as a Spinning Cone Column. Here the juice temperature rapidly drops, as individual evaporating molecules consume energy as they go from liquid to gas phase in the evaporation process. As the remaining evaporation-cooled molecules left behind mix with hot set-point molecules, they accept some of that damaging heat energy again. If evaporation were to simply continue without adding more heat, all the remaining liquid phase juice molecules would finally achieve a reheated or cooled temperature below the heat-damage temperature for the juice, eventually transferring heat to molecules in the juice at a low temperature where flavor and nutritional components would not be destroyed. But instead, when the juice reaches a low temperature considered too inefficient, the juice is often pumped back to a heating element, where the high temperature heating process starts all over again. In all cases, since the intended temperature is finally reached by gradually cooling severely overheated juice, a net destruction of flavor and nutrition is unavoidable. Thus, the heating process to achieve the set point temperature involves a great deal of unacknowledged higher-temperature destruction of flavor and nutrition. In the example of steam-heated types of devices used to make juice concentrates, we find particularly extensive destruction of flavor and nutrition, due to rapid juice boiling, from direct juice contact with large-area steam-heated plate or tube surfaces.

### PRIOR ART

Low Temperature Distillation Prior Art: Almost all previous actively heated low temperature methods cite operating temperatures that are substantially higher than the subject cold bubble operating temperatures. Those previous methods can be considered “low temperature” only by comparison to higher temperature methods that preceded them, but they are not low temperature compared with the cold bubble method. The aroma stripping temperatures of the cold bubble method range from ˜60 degrees Fahrenheit down to just above the distilland freezing temperature of the processed product, which varies between products, and also varies as a function of vacuum pressure. Alcohol and water stripping temperatures can range from ˜75 degrees F. to almost freezing.

References pertinent to the discussion of this section are listed below:

| | |
|---|---|
| 3,957,588 | Humiston |
| 4,499,035 | Kirkpatrick et al |
| 4,510,023 | Bennitt et al |
| 4,585,055 | Nakayama et al |
| 4,828,660 | Clark et al |
| 4,880,504 | Cellini et al |
| 4,938,868 | Nelson |
| 4,953,538 | Richardson et al |
| 4,995,945 | Craig |
| 5,207,875 | Zapka et al |
| 5,211,816 | Youngner |
| 5,332,476 | Lee |
| 5,525,200 | LaNois et al |
| 5,534,118 | McCutchen |
| 5,624,534 | Boucher et al |
| 5,632,864 | Enneper |
| 5,814,192 | Pittmon |
| 5,922,174 | Youngner |
| 6,051,111 | Prestidge |
| 6,189,550 | Petschauer |
| 6,306,307B1 | McGregor et al |

A sampling of representative low temperatures in heated distillation prior art is useful. Craig U.S. Pat. No. 4,995,945 for example, cites the use of their rotating cone column for flavor stripping applications at a temperature of 65 C to 70 C degrees, which is 149 F to 158 F (column 8, line 38). Boucher et el. U.S. Pat. No. 5,624,534 states that the preferred embodiment, “VSC unit 10 is designed so that the temperature of the vapor product will not usually exceed 99 degrees F” (column 14, line 9); with other temperatures mentioned usually ranging from 95 F to 140 F, but up to 212 F in one application. Humiston U.S. Pat. No. 3,957,588 illustrates the efficacy of their system by citing that a process condition “temperature of about 49 degrees to 52 degrees C. (120 F to 125 F), is utilized as a feed stock for the system”, (column 11, line 31). LaNois et el. U.S. Pat. No. 5,525,200 says liquids in their apparatus are “ . . . boiled and evaporated at low temperature due to low pressure created by a vacuum pump”, but makes no mention to the temperatures or vacuum pressures used (column 1, line 39). Since the addition of vacuum is the essential novelty of this patent, and particular low temperature claims, or even discussion of especially low temperature performance is absent, no particular efforts to operate at cold temperatures, is assumed. Youngner U.S. Pat. No. 5,922,174, like his U.S. Pat. No. 5,211,816 and his several other similar patents, does not state any specific processing temperatures. In '816 he does make mention of heating methods “such as flat plate solar collector or by an industrial process” (column 3, line 44). In '174 we find reference to a vacuum pressure of 29″ Hg (column 5, line 47), and “energizing” the warm side and cold side heat exchanger (column 5, line 23). At this low quality vacuum, we may infer high boiling temperatures. Cellini et al U.S. Pat. No. 4,880,504 uses both sides of a commercial refrigeration unit for distilling seawater, but adds a vacuum pump to lower temperatures and save energy. U.S. Pat. No. '504 does not state the evaporation boiling temperature, but the boiling chamber encloses the hot condensing coil of a refrigeration unit under partial vacuum (column 1, line 43). Such coils are typically too hot to touch, so the distilland is subjected to direct contact with temperatures that are certainly in excess of at least 100 F degrees.

Two patents claim a method of distillation that does not require active heating, and both these patents do not provide any active means of heating. In both cases however, the distillate is actually heated, but by passive means, from nearby sources. The first is Prestidge U.S. Pat. No. 6,051,111, which claims “to vaporize water from contaminants without the need to heat the solution” (column 2, line 48). We read elsewhere in '111: “It is preferable that the vacuum be no less than 15 mm Hg or else the water will freeze” (column 4, line 14). This 15 mm of vacuum, or a little over ½ inch (0.59″ Hg) of vacuum is truly miniscule, representing less than 2% of the perfect vacuum of ˜30″ Hg. Even at this slight degree of vacuum, the '111 patent freezes the water around their water evaporation means, which is the small oscillating electrical charge device shown in their FIG. 1 drawing as [110]. Using the words: “The water will freeze”, is another way of saying that the water vaporized by their oscillator, is consuming heat. Looking at their FIG. 1, we can see that they may simply be unaware of the heating mechanism at work in their device, which is convective heat exchange between the water surrounding oscillator [110], and the liquid in the collecting chamber [100]; supplemented as needed, by the body of untreated water [140] through large hole [105]. It is clear that for the small amount of water vaporized at any given time by the tiny oscillator [110], operating within container [130] and near collection chamber [100] of the relatively large size pictured in FIG. 1 (compared to the size of the oscillator), the vaporized water is easily heated by the passive heat exchange sources named above, and needs no active heating means. They are able to vaporize water, in the words of '111: “without the need to heat the solution”, but I suggest “by active means” should have been added, for clarity. While it is not shown what temperature the actual vaporizing liquid is subjected to, vaporization is shown to occur at the very small water surface area located between the electrodes and within the convoluted gap [210], where frictional heating would also certainly play a part. Any practical application would require a massively scaled-up version of oscillator [110] to achieve significant volumes, which then will need active heating means at significant elevated temperatures, to overcome the scaled-up freezing problem.

The second unheated distillation patent is McCutchen U.S. Pat. No. 5,534,118. A close reading of '118, reveals that embodiments such as FIG. 1 are intended to be submerged in a large body of distilland that provides the heat for evaporation and accepts the heat of condensation. Embodiments such as those shown at FIGS. 2, 4a, and 4b, essentially recirculate the heat between evaporation and condensation internally, as stated in '118 (column 19, line 22): “However it should be noted here that the latent heat released by the vapor upon condensation finds a heat sink in the distilland, which is cooled by the evaporative process, thus the energy within the system is conserved and the distilland is maintained at approximately the same temperature; (and column 4, line 25): In the preferred embodiment for desalination, condensation of distillate is facilitated by heat exchange with the distilland, and vaporization of the distilland is facilitated by the latent heat released by condensation of the distillate. There is no mention of distilland temperature in the area of, or at the point of vaporization, or of additional localized frictional heating as a result of high-speed cavitation. We know that vaporization is occurring within a large body of liquid having an ambient temperature. Frictional heating will increase the temperature above ambient, and will increase temperature the most at the locations of greatest friction. In this case, frictional contact locations are those locations where liquid touches spinning metal. These locations of highest liquid temperature will coincide with the locations where actual evaporation is occurring: the locality of vaporization. In this case, in which motion is rapid enough to create a state of continuous cavitation, frictional heating from the rapidly spinning disks will be subjecting the immediately contacted ambient liquid and adjacent ambient liquid, to additional thermal spikes. Evaporation will occur the most at locations where conditions for evaporation are thermally the best: where frictional heating is the greatest. We can infer that evaporation occurs in U.S. Pat. No. '118 at temperatures above ambient, and probably significantly above ambient.

From this low temperature prior art review, it is concluded that:

1. No prior art method of distillation employing intentionally heated distilland was discovered operating at the temperatures of the present invention: between distilland ambient and distilland freezing temperatures.

2. The two prior art methods of distillation employing incidentally heated distilland, made no effort to determine temperatures imposed upon the distilland, but both methods involve well known evaporation mechanisms and frictional heating mechanisms. These methods must therefore be evaporating at temperatures above ambient. If such methods were to be scaled up for practical food volumes, coincidentally magnifying these heating mechanisms, the methods would certainly result in high distilland-damaging temperatures.

Distillate-Stripping Bubble Manipulation Prior Art: Extensive searching produced little prior art pertaining to the present invention's several methods of manipulating bubbles; of creating, controlling and exploiting the exact motions of each individual rising bubble in a distillate, whereby distillate stripping is improved.

In the few cases where bubbles are used, most patents simply allow bubbles to rise to the surface of a liquid, such as Lee U.S. Pat. No. 5,332,476. In one of Lee's embodiments however, he does attempt to lengthen the path of bubbles rising between plates. This embodiment has plate “projections” to form “serpentine paths” (column 5, line 31) to “minimize the energy required”. While Lee '476 attempts only to increase bubble path length, and he envisions bubbles moving back and fourth along his horizontal paths, an examination of his drawings reveals that increased bubble path length will not occur.

Looking closely at FIG. 4, it can be noticed that the rising bubbles will not follow the path indicated. Please note that any given plate projection will have large corresponding portions of adjacent plate projections that project in unison with portions of that given first plate projection. Corresponding parts of the projections of adjacent plates, both front and back, projecting in unison with that first referenced plate projection, create continuous open gaps between all projections that allow bubbles to rise right past the horizontal projection entirely, and rise directly upward between the synchronized portions of projections forming the gaps. The bubbles simply rise straight up to the top through these gaps, since the synchronized projection portions all line up vertically, and consequently do not form the intended blockages for the bubbles at those locations. It should also be noted that even if an elaborate series of non-synchronized projections were somehow created, the stream of bubbles moving along the intended paths would still not occur, because there is no ascending slope to these strictly horizontal projections. The first group of bubbles to rise up against any blocking projection will simply join together to form one static continuous horizontal gas column beneath each projection. Subsequent bubbles will rise up, only to combine with the formed gas column, and all gas will move directly through the column, following the path of least resistance. Bubbles will re-form only at each of the vertical components of the bubble path, with all vertical components totaling to the same bubble path length as if there were no projections at all. The horizontal gas columns will be particularly ineffectual, having none of the advantages of intact moving bubbles. Like an Escher drawing, FIG. 4 looks functional, but on closer inspection we can see that it simply will not work as advertised. If Lee U.S. Pat. No. '476 could somehow be revised by someone skilled in the art and made to actually work, it has not got the capacity to be transformed into performing the several exact bubble manipulations that constitute bubble derived heat transfer efficiency enhancements of the subject invention.

Turning to McGregor et el. U.S. Pat. No. 6,306,307, which patent positions parallel separator elements above a manifold emitting fine bubbles, because “The bubbles tend to sweep retentate away from the surface of the pervaporation membranes” (column 7, line 61). We can see that the bubbles of '307 are not being manipulated, and are not even involved in stripping. U.S. Pat. No. '307 simply puts its elements in the way of rising bubbles, and hopes for improvement in retentate dislodgment. There is no recognition of the unique characteristics of bubbles and bubble films, or any attempts made to manipulate individual bubble motions or bubble performance.

Richardson et al. U.S. Pat. No. 4,953,538 claims that air bubbles rising through troughs of maple syrup sap create a vigorous frothing action, cause agitation, cause scouring of the metal trough wall surfaces, greatly increasing transfer of heat, and saturating the air with moisture as it passes through the sap (column 6, line 57 & 67; col. 7, line 3). While '538 may be effective compared with previous syrup production methods, his FIG. 4 depicts the air bubbles described, as shown at #102. These bubbles simply rise freely up to the surface of the trough, wherein there is no thought given to maximizing individual bubble performance.

Several incremental improvements on conventional methods were found involving bubbles, for example: Zapka et al. U.S. Pat. No. 5,207,875 uses porous aeration stones to inject gas into seawater, forming “seed bubbles” for removing dissolved gas from the seawater (column 2, line 15). Again, there is no attempt at actual bubble manipulation or maximization here. Clark et al. U.S. Pat. No. 4,828,660 is a fundamentally conventional water stripping function performed on unconventional materials (Column 7, beginning at line 66). Little attention was given to individual bubble performance, as commercial lab glass components were used. Bennett et al. U.S. Pat. No. 4,510,023 has an improvement to a conventional bubble cap distillation process (column 3, line 20). Nakayama et al. U.S. Pat. No. 4,585,055 uses bubbles merely to move distillate from one chamber to another (column 4, line 47), and bubbles are produced at lower distillate temperatures, by boiling small portions of the distillate within a porous layer on the outside of heat transfer ducts (column 3, line 23 and column 4, line 6).

Prior art bubble use within a liquid has been granted for some applications completely unrelated to the present application, such as: Youngner U.S. Pat. No. 5,922,174 traps bubbles of gas in a falling column of liquid, to create a vacuum in the chamber at the top of the column (column 4, line 23). Pittmon et al. U.S. Pat. No. 5,814,192 injects steam bubbles into distilland vortices to increase turbulence, to have a scrubbing effect on internal tube walls, and increase heat exchange efficiency (column 2, line 14).

Some prior art was found that makes improvements to gas-liquid contacting trays in distillation columns to increase efficiency of the stripping gas. One example of this type is Kirkpatrick et al. U.S. Pat. No. 4,499,035, who makes changes in the tray configuration that cause a lower velocity and more uniform liquid flow across the tray to promote more uniform bubbling (column 6, line 11). Another distillation column tray configuration improvement involving increased gas path length (does not strictly involve bubbles), was Petschauer et al. U.S. Pat. No. 6,089,550, with vapor flow deflectors positioned above perforations in dual-flow fractionation trays. “Compelling the vapor flow to move with a horizontal motion component lengthens the time during which the vapor contacts the liquid and hence the mass transfer efficiency of the tray” (column 2, line 21). Bubbles are not involved, and the added length of time for vapor contact is very small. It can also be seen that the two methods of attaching the deflectors to the trays are unacceptable for food processing, as both methods involve many small cracks or cavities where juice and particulate would become trapped, and resist dislodgement during cleaning (see attachments in FIGS. 2&3).

Reviewing all the distillate-stripping bubble manipulation prior art, it can be clearly seen that the intent and methods of deliberately manipulating and sequentially orchestrating individual stripping bubble characteristics such as shape, size, residence time, temperature, and direction, for the purpose of improving evaporation, has not been publicly articulated. Nor have methods of intentional and nuanced bubble abutment against selected surfaces, such as degree of contacting and rubbing intimacy with which individual bubbles impinge upon those surfaces, been previously conceived. Nor could these new bubble evaporation efficiencies taught by the present invention, possibly be derived from any combination of prior art examples.

Froth and Mist Centrifuge Prior Art: Contamination of the distillate due to distilland splashing, or entrainment of minute droplets of the distilland among the gas phase distillate stream, are problems that must be avoided with ingestible distillations, details which are not as important for non-food applications. Consequently, these details are casually addressed or not considered at all by much prior art unconcerned, or not primarily concerned with foods. A third common problem is expeditiously eliminating any excessively large volume of slowly collapsing bubble froth, particularly in vacuum distillation. We find little prior art that intentionally addresses one or more of these important problems.

One patent already cited, claims “cyclonic vortices” combine with centrifugal force to expel mist droplets. McCutchen U.S. Pat. No. 5,688,377 states (column 3, line 40), that “Purity of distillate is achieved by dynamic scrubbing of the vapor . . . ” within the passage, or space between the spinning disks. His cyclonic vortices are claimed to have axes of rotation approximately in the plane of this passage that cause mist droplets to contact the surfaces of the spinning disks, whereupon the droplets are flung back into the distilland by centrifugal force. To the degree that cyclonic vortices are created, we know that all cyclones draw vapor, plus any entrained liquid, particles, etc., up along the inner wall of the cyclone, and then back down on the outside of the cyclone. By classic cyclonic construction then, all entrained mist will be drawn up within the inner cyclonic vortices, protected from contacting the disks and being flung out while within the vortices, and apparently some of which entrained liquid does reach the central shaft and passes with the distillate to the condensation apparatus. This conventional cyclonic phenomenon would explain the passage in the patent that informs us that the McCutchen technology collects impure distillate: “Spacing between discs depends on the desired degree of distillate purity . . . (column 7, line 29)”.

If the two spinning disks were counter-rotating, it would be more reasonable to assume cyclonic behavior between the disks. The co-rotating disks in this case, are more likely to produce laminar flows of vapor and mist between the disks, flowing to the vacuum source in the central hollow shaft. Laminar flow of a vapor layer under vacuum, flowing between high speed disks, would be expected to aspirate distillate mist droplets, with the spacing between disks determining droplet size. Cyclonic vortices or laminar flow; either way, we would expect contamination of the distillate, which is verified by the cited passage of U.S. Pat. No. '377 as providing distillate at relative degrees of purity, depending upon disk spacing. This would not be acceptable for food grade applications.

Nelson U.S. Pat. No. 4,938,869 stands a vertical metal sheet coiled at least one revolution within his boiler chamber, which alone is his mist collector (column 4, line 40). The centrifugal effect of evaporating vapor tending to spiral as it expands is supposed to be enough to deposit all mist droplets upon the sheet before removal through the boiling chamber outlet port (column 4, line 61). A partial vacuum in the condenser chamber draws in everything that exits the boiling chamber, where it is condensed and considered treated liquid (column 5, line 43). While this method may be adequate for making acceptably potable water from seawater, the coiled metal sheet method of mist collection appears self evidently inadequate to provide the distillate purity necessary for food applications. In “FIG. 3B” for example, the mists arising from the center area of the boiling chamber, being at the end of the spiral where no spiraling whatsoever can occur, all vapors and mists may only expand straight up to the boiling chamber outlet port #32.

Enneper U.S. Pat. No. 5,632,864 will undoubtedly perform as advertised when boiling water at ambient pressures, where drops and mist accumulated in the porous media may simply drip back into the distilland (column 1, line 66). Unfortunately, at cold temperatures and under vacuum pressures, the distillate residues that accumulate in the media will freeze in the media, quickly blocking distillate flow to the vacuum. Droplets and mist collected in the media, continue to evaporate distillate from their location in the media, but these accumulations quickly freeze at temperatures typically near freezing, cut off as they are, from the low temperature distillate heating source.

These few examples of cited art are all that could be found when searching for centrifuge prior art, or removing froth or mist within the distillation classification.

Cold Condensation Prior Art: No prior art examples were found of condensing a distillate in the solid phase, wherein the distillate is intentionally captured as ice. Since all prior art distillation operates at substantially higher temperatures than the present invention, condensing a solid phase distillate from the gas stream is counterintuitive, and would explain the absence of work in this area. The method of the present invention, wherein the distillate molecules are only slightly above freezing as they depart the distillate, or perhaps already below freezing, has not been practiced. Capturing cold distillate molecules in a solid phase, when those molecules are already near or below freezing as they exit the distilland is a new situation, where it now becomes a good way to conserve energy, provided a practical method of stripping the ice from the capture device can be shown.

Prior Art Conclusion: High temperature destroys flavor and nutrition in foods. This fact has long been known among some food technologists and food processors, but has in the past few years become widely known, even among the consuming public. Yet, as clearly indicated in the above review of prior art, little progress has been made to develop new legitimate cold temperature processing methods. Improvements in the area of “low temperature” distillation have been incremental temperature reductions by refining old methods. Events in the news show almost weekly, that the need for nutrition and flavor in foods everywhere has not abated, but continues to increase. There is a clear worldwide need for completely new methods that perform needed processing steps without application of destructive temperatures. The present invention provides such a technology, that it may contribute to providing badly needed nutrition to all peoples everywhere.

### SUMMARY

An apparatus operable for separating a volatile liquid from a solution comprising the volatile liquid, wherein the solution is maintained at a temperature that is greater than the freezing temperature of the solution and less than the boiling temperature of the solution is described. The apparatus has at least one vertical bubble tube with an open upper end having solution injection means in fluid communication therewith, the solution injection means being operable for introducing the solution into the bubble tube, and a lower end in opposition to the upper end. Gas injection means are disposed at the lower end and are operable for introducing a gas into the lower end of the bubble tube. The gas forms bubbles which rise through the bubble tube to collect and transport a vapor phase of the volatile liquid into the upper end. Vacuum means are included for maintaining a reduced pressure above the open end of the bubble tube. A froth and mist arrestor is disposed downstream from the upper end operable for enabling only the vapor phase of the volatile liquid to pass therethrough. Vapor collection means disposed downstream from the froth and mist arrestor are operable for collecting the vapor phase that passes through the froth and mist arrestor. A flow stream of molecules comprises the vapor phase of the volatile liquid, wherein the molecules have a range of masses, and wherein the flow stream defines a path through the apparatus originating at the lower end of the bubble tube, passing through the froth and mist arrestor and terminating at the vapor collection means.

### DESCRIPTION OF THE PRESENT INVENTION

The subject invention uses extraordinarily low-temperature distributed-heat thermal transfer methods. Choosing to operate at “cold temperatures” defined as between ambient and freezing under vacuum (between less than 85 F and ˜42 F degrees for water based food liquids), since no heat destruction of flavor or nutrition occurs at temperatures this low. Concentrating juice at cold temperatures is a challenge however, and necessitated creation of new methods and devices to make effective cold temperature distillation possible.

Unique Cold Bubble Method: While bubbles are sometimes used in distillation technologies, their great potential has gone largely unexercised, and where previously used, bubbles have been relegated to the most simplistic functions of which they are capable. Without the influence of other forces, the surface tension of bubbles exerts a force against enclosed gas that finds equilibrium by forming a perfect sphere. When a bubble is deformed, the force it exerts to return to a sphere may be put to work to serve practical purposes. Non-spherical bubbles can be articulated: can be deflected, elongated, flattened, flexed, hinged, convoluted, pivoted, twisted, etc. All these articulations result in small forces from the bubble as its surface film attempts to return to the spherical shape. Complex combinations of forces result when outside forces are imposed upon bubbles, such as gravity, buoyancy, friction, hydraulic flow, pressure, temperature, centrifugal force, etc. There is opportunity to use bubbles in many ways that have been previously unexploited, and this invention puts these forces to work.

The cold bubble method combines the full flavor and nutrition of fresh squeezed juice, wine, balsamic vinegar, or other unprocessed liquid food products, with the storage and shipping advantages of a concentrate, thus providing one of the best sources for satisfying much of the world demand for high flavor/high nutrition at reasonable cost. The present invention is the first commercial method to perform aroma recovery below 85 F degrees, and perform juice concentration below 95 F degrees, which are the claimed lowest operating temperatures of the two types of spinning cone columns commercially sold by Flavourtech, believed to be the lowest temperature vacuum evaporation equipment sold today.

The cold bubble method will find application not only in juice and beverage concentration, but also in aroma and flavor recovery, essential oil extraction, chemical separations, alcohol reduction of beverages, and many other uses.

A. An object of the present invention is to provide a continuous counter-current liquid-gas contacting method of stripping volatiles from a liquid stream, which performs non-mechanical active volatile stripping using bubbles; or specifically, by manipulating stripping gas in the form of bubbles, continuously rising through the liquid.

B. Another object of the present invention is to provide a method of volatile stripping that continuously heats the liquid being processed, continuously strips volatiles, and can strip to higher viscosities, so that feedstock liquids can be stripped to a greater degree in a single pass than is currently possible with most other methods.

C. Another object of the present invention is to provide a low-temperature mass transfer method of volatile stripping, utilizing a large distributed heated surface area with a small thermal differential between heated surface and processed liquid, relying upon short thermal transmission distances within the liquid, rapidly moving heat transfer media, and active non-mechanical mixing methods to sustain stable cold temperature mass transfer of evaporated volatiles with operating temperatures much lower than conventional methods, thus preserving the flavor and nutritional constituents of processed food products that are normally destroyed by processing heat.

D. Another object of the present invention is to provide a method of non-mechanically controlling the stripping enhancement motions of each stripping bubble, embodied in the array of bubble tubes, to maximize non-mechanical continuous heat scrubbing and volatile stripping performance of every bubble, with non-mechanical particulate suspension, thermal mixing within the tubes, and directional fluid flow when needed.

E. Another object of the present invention is to provide a non-mechanical method of stripping enhancement in the form of tube perturbations, for maximizing volatile-stripping bubble efficiencies. These perturbations, referred to here as “bubble turbulators”, create turbulent bubble-films and turbulent bubble-gas environments which: accelerate heat distribution within both the liquid and the gas environments by non-mechanical liquid mixing and internal bubble-gas mixing; slowing down bubble rise to increase bubble residence time; cause bubbles to aggressively scrub heated liquid directly from tube walls by causing a high percentage of direct wall contact by rising bubbles, moving the warmest liquid away from direct tube-wall contact and causing that warmest liquid to mix with coolest liquid in the center of the tube; using bubbles to vigorously mix tube liquid and suspended particles, maintaining better suspension and more thoroughly scavenging solvents from both liquid and solids; actively mix heat stratified and solvent-saturation stratified interior bubble gases by deforming rising bubbles; and continuously agitate and refresh the material exposed to both sides of the evaporation surface interface (the stripping gasses on one side and liquid distilland on the other side of the bubble film) that exists between liquid material and stripping gases, to non-mechanically accelerate solvent stripping and assure complete solvent saturation of the stripping gas.

F. Another object of the present invention is to provide a method of renewably multiplying evaporation surface area, whereby a renewable surface area (bubble film) moves through the liquid, rather than the liquid moving across a non-renewable solid surface area (as with spinning cone and all other thin-film methods), which: provides virtually infinite surface area for the gas to scavenge solvent from the liquid; eliminates dependency on high temperature as the principle method for affecting solvent evaporation performance during very limited surface area exposure time; embodies gentler stripping characteristics, that inherently preserves delicate food liquid constituents of flavor and nutrition; and exposes the liquid to a much larger square footage of evaporation surface area than similarly sized conventional machines, to eliminate high temperature as the primary means for achieving acceptable efficiencies.

G. Another object of the present invention is to provide a method of capturing sub-freezing stripped molecules from the gas stream before they reach the vacuum pump, through the use of a “freeze-condenser array”, which: freezes stripped volatile molecules out of the gas stream onto an array of freezer tube-elements; traps volatile molecules swept up in the expanding gas stream, because such molecules seldom make the several turns required to escape capture, without contacting and freezing upon one of multiple tube surfaces, thus assuring capture of the evaporated volatile molecules.

H. Another object of the present invention is to provide a method of performing ice removal without mechanical motion. The method uses “single ended” freeze-condenser tubes that efficiently “self-strip” captured volatile ice from the freeze-condenser tubes, using freeze/thaw cycling of duel arrays of single-ended tubes.

I. Another object of the present invention is to provide a method of operating freeze filter arrays that enables continuous operation of the tower during ice removal operations. This double-vee method, or “vee” configuration with dual freeze-condenser arrays, flow path valves, and lock-out melt chambers: provides uninterrupted tower operation during ice removal; and incorporates a reverse flow component in which the operating array can scavenge residual volatiles from the opposing freshly stripped array before reversing roles, thereby eliminating any loss of stripped volatiles during the ice removal cycle.

J. Another object of the present invention is to provide a method of isolated melting of ice removed from freeze-filter elements, which: constitutes a separate melt chamber, easily segregated from the vacuum system; permits unhurried melting of volatiles after freeze capture, preventing heat damage at this stage due to rushing the melt process; and provides for pumping of cold liquid volatiles to tank storage or blending.

K. Another object of the present invention is to provide a method of interchangeable tower bubble tubes, in which a basic design can be configured or reconfigured to: strip both juice volatiles, and concentrate juices; perform either low temperature (such as floral volatiles) or high temperature (such as brewed teas/coffees) processing; perform either high viscosity (pulp slurries) or low viscosity (chemical extractions) processing; operate as a single unit performing multiple tasks, or operate as one of several specialized units linked together into larger systems performing simultaneous multiple diverse tasks, such as multi-stage stripping and concentrating, or processing progressively greater product viscosities.

L. Another object of the present invention is to provide a method of capturing sub-freezing stripped molecules from the gas stream in conventional condensers (requiring higher temperatures), by passing them through a heat exchanger to warm the molecules first. Such a method will permit cold concentrate processing, and effective capture of sub-freezing stripped volatile molecules, without using the option of freeze filter arrays.

M. Another object of the present invention is to provide a method of volatile stripping which can extract volatile flavor compounds, and subsequently concentrate juices or other food liquids, using the same equipment for both concentration and volatile stripping.

N. Another object of the present invention is to provide an open-ended centrifuge for continuously stripping liquid and solid particulate from an uninterrupted gas stream that continuously flows through the centrifuge.

The several objects of the invention are accomplished by the preferred embodiment and various options that may be included. The inventions method of operation and details of construction are most clearly understood when considered in conjunction with the following drawings, which follows.

### BRIEF DESCRIPTION OF THE DRAWINGS

FIG. 1. Cold Bubble Tube Tower, Front Elevation and Plan View.

FIG. 2. Cold Bubble Tube Tower, Side Elevation and Plan View.

FIG. 3. Sections A-A and B-B of FIG. 2.

FIG. 4. Sections A-A and C-C of FIG. 2.

FIG. 6. Section E-E of FIG. 1: Splash Arrestor Disc, Through-hole Pattern.

FIG. 7. Details of Bubble Characteristics.

FIG. 8. Detail 1 of FIG. 4: Bubble Forming and Migration into Bubble Tubes.

FIG. 9. Detail 2 of FIG. 4: Continuous Volatile Stripping.

FIG. 10. Detail 3 of FIG. 4: Splash Arrestor & Mist Arrestor.

FIG. 11. Simple Turbulator: Axial Section and Longitudinal Section F-F.

FIG. 12. More Complex Turbulator: Axial Section and Longitudinal Section G-G.

FIG. 13. Cold Bubble Volatile Stripper with Condenser, Plan View.

FIG. 14. Cold Bubble Volatile Stripper with Freeze-Condenser, Plan View.

FIG. 15. Section H-H of FIG. 14: Freeze-Condenser Linear Section.

FIG. 16. Section I-I of FIG. 14: Freeze-Condenser Axial Section.

FIG. 17. Detail 1 of FIG. 15: Freeze-Condenser, Tube Array.

FIG. 18. Froth & Mist Centrifuge: Elevation, Sec. J-J, Detail K, Isometric L, Sec. M-M.

FIG. 19. Wine Concentrate Alcohol Removal.

FIG. 20. Material processed.

FIG. 21. Alternate Equipment Set-Up Example

### DETAILED DESCRIPTION OF THE PREFERRED EMBODIMENTS

Cold Volatile Stripping: The concept of stripping volatiles by evaporation at distillation temperatures between ambient and freezing, is so counterintuitive as to seem self evidently ridiculous. Thousands of inventions have been granted for various evaporative forms of stills; numerous types of thin film and other distillation columns, agitated and rotating mechanical motion types of co-current or countercurrent liquid-gas contacting methods, and various other types of separators, evaporators, and concentrators. All of these various devices use high temperature, or recent so-called “low temperature” evaporation as a fundamental requirement. For example, the lowest possible useful temperature in actual production equipment multiple-stage juice concentrate technologies is 120 F degrees, with all other stages at progressively higher temperatures. Developments in juice distillation have been toward more efficiency, which results in significantly higher temperatures. In a new consumer trend, customers are seeking more flavor and nutrition in foods. It is widely known on the production side, that heat destroys the flavor and nutritional ingredients of foods, but until recently, product quality has not come before low price in the consumers mind, and higher processing temperatures drive costs down. New customer demand for more quality has been reshaping the marketplace.

Recent customer demands for more flavor and nutrition have redistributed market share. The popular method of juice purification called Flash pasteurization uses even higher pasteurization temperatures. The high temperature is imposed for shorter time duration, to reduce overall flavor destruction. In cases where lower temperature devices have been successfully developed, complex and high maintenance mechanical methods have frequently been required. Such machines operate at so-called “low temperatures”, which are actually hot or burning to the touch. The temperature is only “low” when compared to previous technologies used to accomplish the same results. Perhaps the lowest temperature devices available today are different versions of the Spinning Cone technology for aroma recovery, or for food product concentration, made by Flavourtech. Their public literature claims operating temperatures of 95 F to 140 F for their “Centritherm” concentrate device, and 86 F to 280 F for their spinning cone column aroma recovery devices. Even the very bottom end of these temperature ranges (suitable for few products) could not be considered cold. Thus, the very thought of performing production distillation and evaporation operations at near freezing temperatures seems impossible, to anyone skilled in the art.

Freezing and near-freezing temperatures are used for food storage worldwide to preserve flavor and nutrition in foods, but only after the high temperature food processing steps have been accomplished. Invention of the subject cold temperature volatile stripping method permits preservation of all of the flavor and nutrition that is present in the starting, or precursor juice, wine, or other food liquid or slurry. Thus, flavor and nutritional attributes of the resultant concentrate or aroma extract are undiminished from the fresh product liquid. This has never been possible in a concentrate, or an NFC juice, or in so-called Fresh Squeezed juices, that all use conventional thermally damaging technologies.

As temperatures increase arithmetically, pressure of vaporization increases geometrically, so the desire to use higher temperatures is very strong. The present invention departs from the traditional high temperature approach. The present invention operates at temperatures between ambient and freezing of the processed liquid. By applying low temperature heat internally, and by developing a new method of coaxing increased volatile evaporation from liquids at such low temperatures, the first capability for preserving the full flavor and nutritional constituents of processed food liquids is created. The same equipment can be used both for aroma recovery, and for liquid concentration. Turning now to the drawings, the operation of this method will become apparent in the following detailed descriptions of the drawings, and other data that follows.

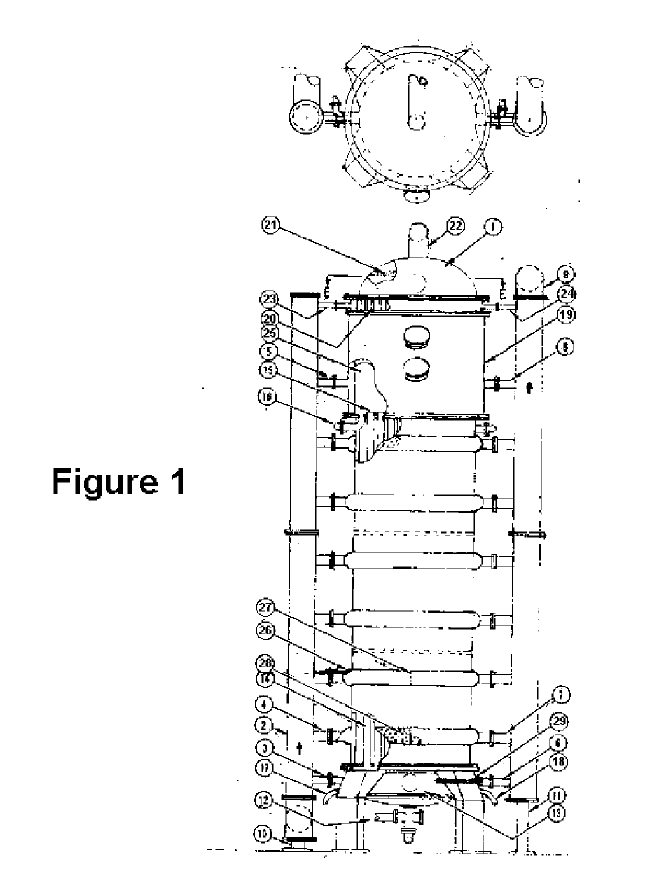

Cold Bubble Tower: Description of counter-current operation of the Cold Bubble Tower can begin with FIG. 1. Shown at [1] is an example of a Cold Bubble Stripping Tower. This particular example shows a 3 ft. diameter bubble tube jacket, and is 16 ft. high. The dimensions are not critical, as size will very with application. The method of distributing heating fluid, or distributing bubbles to the bubble tubes for example, will also depend upon application requirements. There is no fixed proportional relationship either, so the bubble-tube section may be longer or shorter, wider or narrower, and the bubble expansion section may be larger or smaller, etc., etc., depending upon specific material processing requirements, physical space requirements, the type and variety of products to be processed, and other defining or limiting factors. The drawings, and drawing descriptions that follow are only intended to be generically descriptive, are provided as a means of conveying the invention to the reader, and are not intended to be representative of the very wide range of configurational possibilities that these methods and embodiment examples clearly apply to, for anyone skilled in the art. Since embodiments would be continuous processors, there is of course no maximum capacity, provided tank space and packaging equipment is available for handling or storage of the pre-processed and post-processed liquids. Description of the tower illustrated in FIG. 1, depicting a 9″ long jacketed tube section, is as follows:

The heating jacket fluid, such as a conventional Dow Corning thermal fluid, or any other antifreeze type product, is pumped through at high volume and speed, to maintain a stable thermal transfer to the distilland during vacuum evaporation of volatiles. Thermal fluid is fed to the thermal jackets through main fluid delivery pipe [2]. The main fluid delivery pipe can perform a secondary function as a somewhat stabilizing and supporting structural member for a tower of these proportions. Thermal fluid is delivered at the bottom to the bubble distribution chamber heating jacket [13] through fluid delivery pipe [3]; and into the Bubble Tube Array jacket through multiple delivery pipes as at [4], to the Bubble-Collapsing Chamber jacket delivery pipe as at [5] in this example, and to the splash-arrestor disc at [23]. Cross-flow movement of heating fluid is used in this example at all locations using a conventional circumferential distribution half-pipe structure, as at [26], having blocking plates [27], separating input and output sides of the half-pipe, and holes [28] in the heating jacket within the half-pipe for uniform input and output heating fluid distribution.

The continuously flowing heating fluid passes essentially horizontally through all heating jackets and exits the four jackets through corresponding fluid collection pipes on the opposite side of the tower, as at [6], [7], [8], and [24].

All heating fluid collection pipes empty into the main fluid collection pipe [9]. As with the fluid delivery pipe, the fluid return pipe performs a secondary function as a somewhat stabilizing and supporting structural member to the tower.

The foot [10] at the bottom of the delivery pipe, and the foot [11] at the bottom of the collection pipe are isolated from the fluid carrying sections of the pipe, and perform only a structural function of supporting and stabilizing the vertical pipes [2] and [9].

The distilland to be processed (fruit/vegetable juices, wines or other beverages or purees, flavor/essential oil extracts, particulate slurry, etc.) enters the tower through one or more distilland feed pipes, as at [16], then begins to flow down the bubble tubes as at [15], draining down through one or more individual bubble tubes of the bubble tube array, as at [14], to fill the bubble distribution chamber within the heating jacket [13]. When the bubble distribution chamber and the bubble tubes are filled, the distilland forms a shallow pool in the bottom of the bubble-collapsing chamber [25], and is maintained at a sensor-determined liquid level. During processing, the gradually volatile-stripped distilland works it's way down each tube as distilland is gradually withdrawn from the drain tube [12], until the distilland exits the bottom of each bubble tube, such as at [14], passing through the bubble distribution chamber within heating jacket [13], and is pumped out of the tower through drain tube [12] at a controlled rate. During processing, a gas mixture, inert gas, or other application appropriate stripping gas, such as Nitrogen for example, is introduced into the bubble distribution chamber through pipe [17] or [18]. Relative to the downward flowing distilland, the stripping gas in the form of bubbles, moves in a counter-current upward direction. Upwelling bubbles created in the bubble distribution chamber (within heating jacket [13]) find their way into the bottom ends of bubble tubes, rise up through the tubes in the bubble tube array, as at [14], and exit the top of each bubble tube, as at [15]. The bubbles accumulate above the distilland pool at the bottom of the jacketed bubble-collapsing chamber [19] where the bubbles eventually collapse, to release the stripped volatiles and inert gas into the bubble-collapsing chamber [25]. The stripping gas, sweeping along it's burden of accumulated volatiles, passes through a jacketed splash-arrestor disc [20], perhaps an optional mist arrestor media [21], and then exits the tower under vacuum through vacuum pipe [22]. In most cases, this counter-current arrangement (with the bubbles ascending against the downward flowing distilland current) is the most advantageous, but this same apparatus can easily be set up for co-current operation, if that is preferred (see description below). Also shown near the top of FIG. 1, is the location of Detail Drawing E-E (FIG. 6).

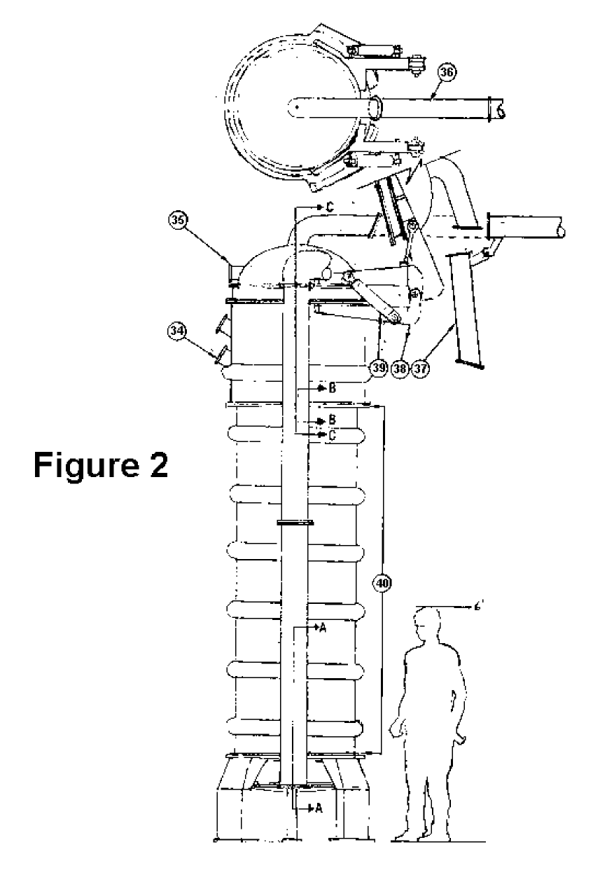

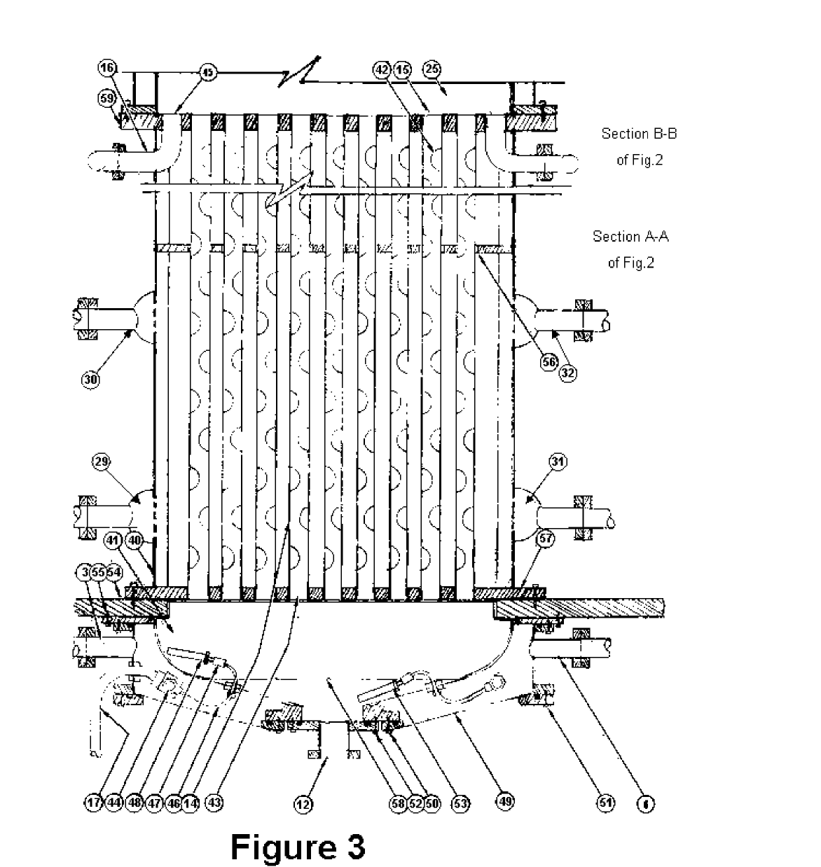

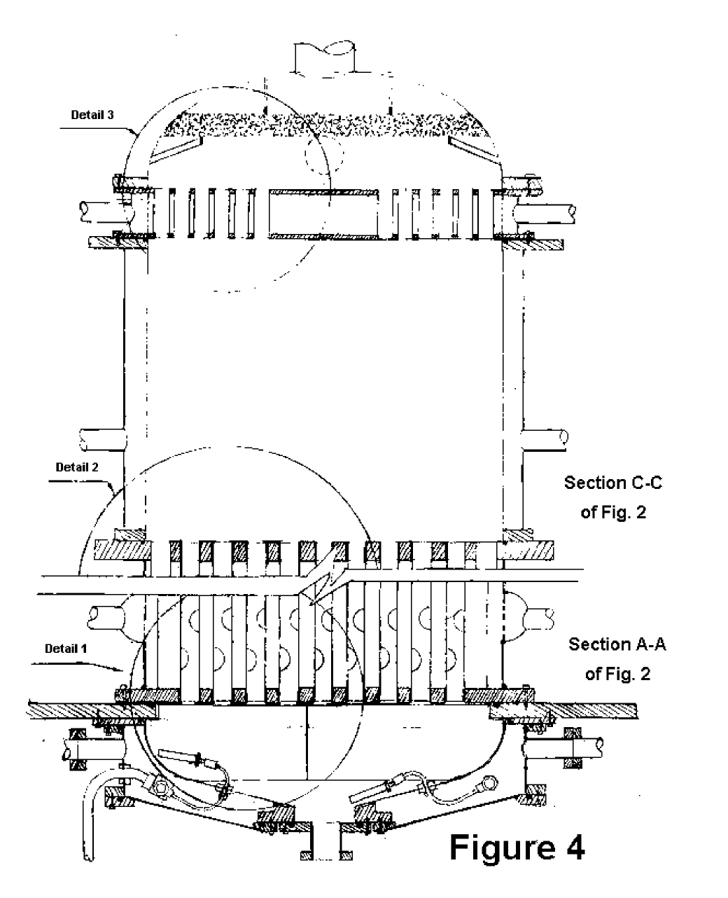

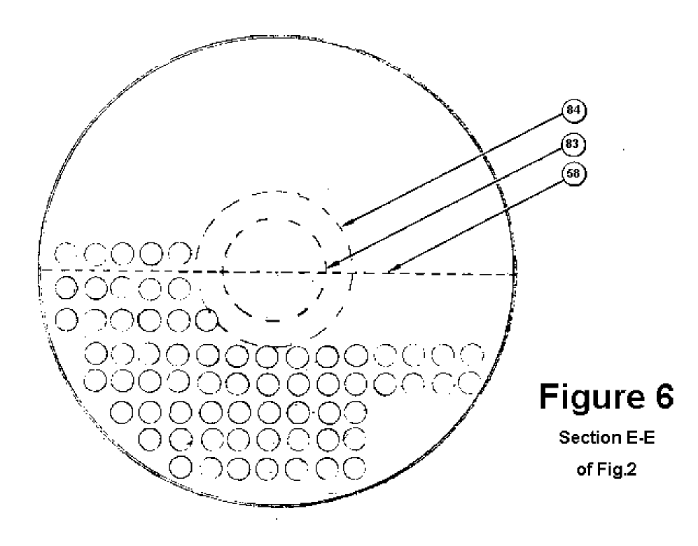

In FIG. 2, we see view ports, as at [34] on the bubble-collapsing chamber and vacuum fore-chamber [35]. These ports are used primarily for determining process parameters for any given liquid product, and calibrating response times for automated valve sensors. If the unit is not fully equipped with CIP (Clean In Place) capability, we see an optional pneumatically actuated hinged lid, to aid in equipment wash-down. This option first requires disengagement of the hinged section of vacuum pipe [36], shown disengaged at [37]. Then the lid may be opened, pivoting on hinges at [38], by activating the dual cylinders as at [39]. The entire tube section of welded bubble tubes can be changed out for another section with different turbulator designs (discussed below), or with larger or smaller tube diameters by unbolting and replacing the bubble tube array shown at [40]. Also shown in FIG. 2, are the locations of section drawing A-A (shown in FIG. 3 and FIG. 4), section B-B (shown in FIG. 3), and section C-C (shown in FIG. 4). The ability to change tower performance by exchanging easily interchangeable parts of the tower increases flexibility. In particular, changing diffusion elements for those with different pore sizes, and the bubble tube array for those with smaller or larger tube diameters, allows processing distillands having great differences in viscosities.

Turning to FIG. 3: (Sections A-A and B-B of FIG. 2), we can see the workings of the top and bottom ends of the bubble tube array within the heating jacket [40], and the workings of the bubble distribution chamber [41]. At the bottom, jacket-heating fluid enters at pipe [3] and exits on the other side of the chamber, at pipe [6]. During operation, as distilland is pumped in at the top into the bubble-collapsing chamber [25] as at location [45], through distilland feed pipes as at [16], the distilland first flows down through bubble tubes as at [15], to fill bubble distribution chamber [41] and then to fill all bubble tubes to the top. Distilland continues to flow into the bottom of chamber [25], forming a shallow pool above the bubble tubes, and is maintained at a predetermined liquid level. During processing, as stripped distilland is withdrawn at a measured rate from the bottom of the tower through drain pipe [12], unprocessed distilland is drawn into the top of each bubble tube as at [15] from the pool, to replace the distilland withdrawn below. The entering distilland is immediately subjected to the streams of upwelling stripping gas bubbles rising through the tubes. As unprocessed distilland progresses slowly down each of the several bubble tubes, it is subjected to a constant turbulent countercurrent stream of gas bubbles that strip volatiles from the distilland. The mixing and stripping action caused by the bubbles is made more aggressive and efficient by the narrow passageway of the tube walls, and by the frequent imposition of turbulators as schematically drawn at [42], positioned all along the tube on alternating sides of the tube, which continuously change the direction of the bubbles rising up the tube. The flow of distilland exiting the bottom ends of the several tubes of the bubble tube array, as at [43] into chamber [41], may be set at any feed rate by a metering pump withdrawing the distilland through pipe [12]. This feed rate is the primary variable for determining the degree of volatile stripping, provided all other factors remain optimized.

Gas Distribution: Inert gas enters the chamber; either unheated or pre-heated, at tube [17], passes horizontally through the heating fluid by way of crescent tube [44], and enters the bubble distribution chamber through sealed pass-through holes for the multiple stripping gas pass through tubes, as at [46]. The gas passes through the check valve at that location, as at [47], and on to the bubble diffusion element [48]. Multiple diffusion elements are positioned within chamber [41], to provide an even distribution of the rising bubbles to each of the bubble tubes. Gas bubbles exiting the diffusion element enter the bottom ends of the bubble tubes as at [43], and rise through the bubble tubes, as at [14]. Removing both inner and outer rings of bolts, as at [50] and [51], allows removal of the bottom circular access panel [49] from the jacket, so that gas plumbing within the jacket can be modified if needed. Removal of the bolts, as at [52] which secure the drain pipe [12], provides limited access to the fittings, check valves, and diffusers within the bubble distribution chamber without removal of the chamber itself. This permits some on-site adjustment or replacement of the bubble distribution chamber internal components.

Please note, as at [53] and [48], that the diffusers can be positioned anywhere within the chamber by bending the tubing in any direction. Note that the entire distribution chamber with end plates and heating jacket can be removed from the bubble tower support plate [54] if necessary, by removing a ring of bolts, as at [55]. If provided, the removed bubble distribution chamber assembly can be taken out by securing the top of the tower and a “bridge leg” (not shown), and then removing the optional front “access leg” shown in FIG. 1 at [29]. This will make removal of the entire bubble distribution chamber possible, and thus make any major changes to the chamber much easier.

Each bubble tube is welded into the bubble tube array top plate [59], passes loosely through intermediate plates, as at [56], and are welded to the bottom plate at [57].

It can be seen in these two Figures that the flow rate of the distilland and the stripping gas are completely independent. This means the bubbles may be run continuously at any rate desired, while the distilland flow rate will be dictated by the desired degree of distilland stripping intended for any particular pass through the tower. In practical terms, there would be two passes of distilland through the tower; the first to capture the aroma volatiles, and the second pass to remove water. For large production volumes, two different units could be used, to optimize specific details such as bubble size and bubble-tube construction in each unit. Unlike plate evaporators, the present process is suitable for higher viscosities, and can therefore achieve higher than conventional juice concentrations. With any pass, the distilland pumped from the tower drain [12], is pumped to a chilled storage tank to await blending and packaging, or the next pass, or with multiple optimized tower units, distilland will be pumped directly to the next unit where it starts the next pass.

Co-Current System: For some uses and applications, it may be desirable for the unit to operate as a co-current system, which begins with the exact unit described above as a counter-current system, but with a few small changes. Considering FIG. 3 for co-current operation, we would pump the distilland into the unit through pipe [12] at the bottom, and stripped distilland would be pumped out of the top, as at pipe [45]. No other equipment changes are required.

Initial Circulation: At the initial filling of the chamber and bubble tubes at the start of stage processing, the first full tower of distilland will not have had the benefit of progressing through the tubes while being stripped. Stripping of this initial volume will occur by recirculating and stripping the initial full tower of distilland for a specific period of time, before starting liquid flow out of the drain pipe. This initial recirculation is accomplished by opening only one of the two gas bubble feed tubes, [seen in FIG. 1 at 17&18], each of which serves to feed gas to only half the bubble tubes, which are shown here in FIG. 3, divided by vertical baffle [58]. Feeding gas to only half the unit causes the rising bubbles to be restricted to entering only half of the bubble tubes, as bubbles are blocked from access to the other tubes by the vertical baffle, also shown in FIG. 6 at 58. With bubbles rising in only half the tubes, this action alone causes upward flow of distilland to occur in that group of bubble tubes supplied with bubbles. The distilland then spills out the tops of the bubble-supplied group of bubbled tubes, then flows over to and down the un-bubbled tubes, setting up a continuous recirculation and co-current stripping of the distilland volume held within the tower. When the initial fixed volume of distilland (including any top-off volume that might be added during this stage) is reduced to the desired level of stripping (determined by eventual liquid level in the bubble collapsing chamber), then adequate stripping of the initial distilland volume is complete. At this point the other bubble gas valve is opened, the fill and drain valves set, and normal counter-current continuous operation of the tower starts. It may be advantageous to switch to this modified batch mode during any part of a continuous operation cycle for some applications. It may be necessary to operate extensively in batch mode for some applications, such as at certain stages of tea or coffee in-tower brewing uses, or for coffee or tea aroma stripping. This duel gas feed with vertical baffle in the input feed system makes it convenient to switch between continuous and batch modes at any time, or operate exclusively in either mode.

Working Bubbles: Central to this invention are methods for making bubbles perform work that is usually delegated to the old distillation standbys of excessive heat and mechanical motion used by other technologies. The next few drawings look at the way bubbles are pressed into service by this invention, to perform the critical volatile stripping work. Referring to “FIG. 4: Sections A-A and C-C of FIG. 2”, we can see more clearly how the entire unit will operate by examining the drawings referred to here as “Details 1, 2, and 3”.

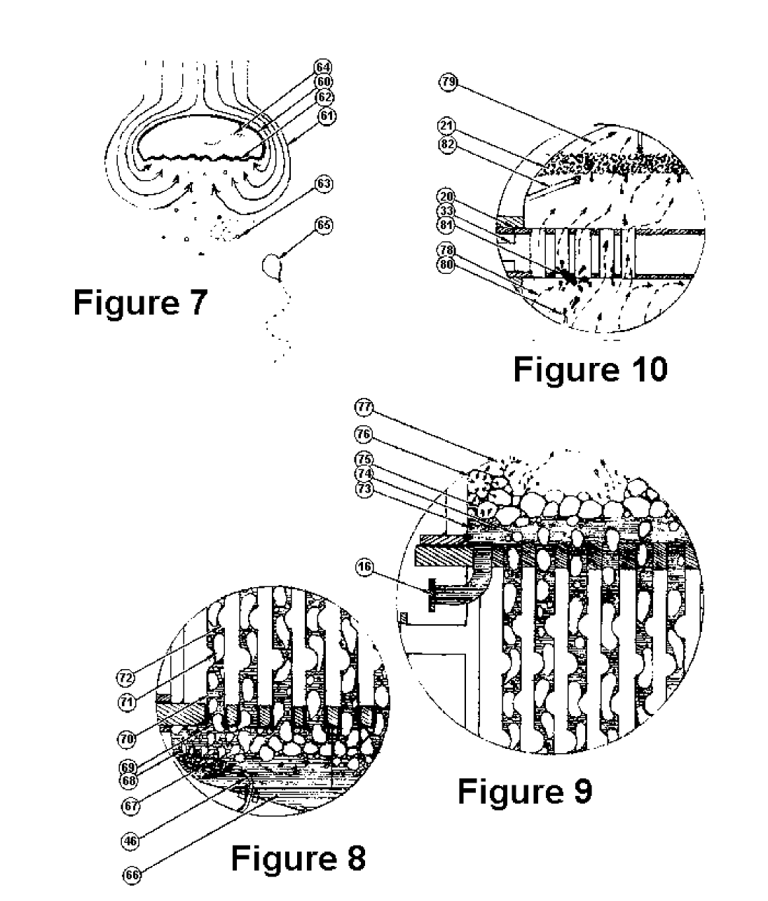

Turning attention first to “FIG. 7: Details of Bubble Characteristics”, we can see the bubble mechanisms that are put to work in the tower. In a 2003 experiment in crystal-clear still sea water (a high content of dissolved solids is more representative of most distillands than fresh water) about 25 feet deep near Makaokahal Point on the island of Kauai, Hi., rising bubbles produced at depth expanded to a maximum size of ˜8″ diameter by ˜3″ high as they rose straight up through the water, until water would eventually break through the smooth top of the ever enlarging bubble to initiate a bubble break up. This process would be repeated several times before the bubbles reached the water surface. Any bubble's trip from depth to surface created several opportunities to clearly observe individual bubble behavior of any size bubble under various modifying conditions. The intact upward pushing top of the bubble [60], vigorously diverts water around the bubble form, shown as at [61]. Water flowing smoothly over the shallow dome top and sides, and recombining under the bubble, causes a very active, yet unbroken undulating surface movement [62] at the bottom of large and medium size bubbles [62], actively deflecting the bubble underside by no more than ¼” in height at most, across the bottom of the largest bubbles.

The recombining of water under the bubble created a surprising degree of swirling and eddies, revealed by the movement of very small bubbles [63] that got caught up in this water recombining movement. Splashing did not occur at the bubble underside, or inside the bubble itself.

Of greatest interest was the observance of occasional visible vapors within the bubbles [64]. The vapors always reveal a slow languid movement of all gas within the bubble—a surprising and unexpected stillness—characteristic of all sizes of bubble interior atmospheres where vapors were observed. Bubbles would not usually achieve this maximum size, since disturbances such as adjacent bubbles, small water currents, objects in the water, or smaller faster rising bubbles from below, would cause the bubble to break up beforehand, into many bubbles of diverse sizes. Bubbles of the larger sizes proved to be the easiest to observe visible vapor within, but bubbles of many smaller sizes were observed to have that vapor-revealing stillness within them. This applied even to bubbles small enough to be inherently unstable, moving side to side with pointed bottoms, as they rose up in the water [65]. This internal bubble stillness was a surprising and unexpected discovery. The atmosphere inside a bubble was seen to approximate the passenger's atmosphere inside a fast moving car, where the presence of cigarette smoke may be observed to rise slowly, and sometimes even to form a stratified layer of smoke in the stillness at the top of the passenger compartment, completely undisturbed by the extreme atmospheric activity outside the vehicle or the turns and lateral movement of the car itself.

The relevant conclusions of this experiment are: (1)—Rising bubbles perform a surprisingly active mixing function beneath bubbles; (2)—Liquid is physically moved aggressively by rising bubbles, creating the scrubbing inherent in juxtaposition of bubble surface films and inner gases pushing against liquid mass or solid surfaces, which is the principle bubble-derived evaporation mechanism; (3)—accelerating bubble-derived evaporation ought to include the previously unrecognized opportunity for agitating in a way that causes “stirring” of the undisturbed inner bubble environment, enabling internal gas mixing, and thus create faster and more complete volatile saturation of bubble gas.

Tower Bubble Behavior: Now turning to “FIG. 8: Detail 1 of FIG. 4: Bubble Forming and Migration into Bubble Tubes”, we see the tower in operation, stripping distillate from the distilland. The liquid distilland is depicted here at [66] with horizontal lines, as shown in the bubble distribution chamber, where the distilland has already been stripped of volatiles as it passed downward through the tubes above, and is being drawn gradually down and out of the bottom of the bubble distribution chamber. The incoming stripping gas, which may be either heated or unheated, enters the chamber through a tube as at [46] in a continuous stream, and is divided into numerous individual bubbles when passing through the diffusion element at that location, as at [67]. The individual bubbles rise and spread out from the diffusion element as at [68], and enter the bottom ends of the bubble tubes in that area, as at [69]. Rising up through the bubble tubes, as at [70], bubbles must push around the schematically depicted turbulators, as at [71]. Any bubble pushing around any turbulator, is thereby lined up to encounter the next turbulator straight on, as shown at [72]. In order to push around that next turbulator, the bubble is momentarily stopped and again forced to move in the opposite direction and squeeze past the next turbulator, and so on, back and fourth, up the bubble tube. This torturous path up the tube, not only slows the speed of the bubble rising up the tube (extending residence time), and is also a longer path for the bubble to take, which increases residence time, but the completely predictable bubble path permits detailed control of bubble motion and creation of bubble articulation.

The action of each bubble always being turned out of the path of it's natural inclination to rise straight up, allows for forcing the bubble to perform each of several stripping functions much more thoroughly along it's path to the top of the tower, using carefully defined turbulator shapes. The bubble is deflected to the opposite side of the tube by every turbulator so that it impacts the next turbulator more directly and forcefully. Along this torturous path, each bubble is deformed as it scrubs past the turbulator, and this deformation performs a heat-mixing function upon the gas within the bubble, even as it wipes the inner bubble gas against the warmer turbulator surface. This intensified bubble motion performs a heat-mixing function upon the distilland within the tube, even as it scrubs the warmest distilland from direct contact with the inner tube wall, involving warmest distilland in the turbulent liquid mixing which occurs beneath each bubble as the bubble passes by, even as scalloped turbulator tips rake the passing bubble gas, to better transfer heat and mix the stratified bubble gasses. Suspended particulate is not only mixed and kept in suspension more thoroughly by this vigorous process, but it is subjected to a higher degree of volatile stripping through more frequent, more intimate gas exposures and more active and thorough heat dispersion within the liquid and within bubbles in the tube.

The stripping gas is enabled to scavenge volatiles more thoroughly, through “bubble-deformation mixing” of horizontal heat stratifications or circumferential solvent-saturation stratifications, as well as the repetitive scrubbing of hottest distilland from the tube walls and immediate mixing-in of heated distilland with colder distilland, and heated gas with colder gas, and the continual exchange of bubble film materials on both the liquid and gas sides of the bubble film where volatile evaporation takes place. All these non-mechanical, manipulated bubble functions collectively perform—at cold temperatures—the aggressive stripping work done by high heat and mechanical motion in conventional evaporation technologies.

Continuous Volatile Stripping: Looking at “FIG. 9: Detail 2 of FIG. 4: Continuous Volatile Stripping”, we see one of the feed pipes as at [16], where all distilland feedstock is fed by metering pump into the tower. Feedstock distilland fills most of the vacuum chamber inside the tower, up to this distilland pool, shown at [73]. Distilland liquid fills the bubble distribution chamber, up through the bubble tubes, and forms this shallow pool above the bubble tubes. The pool gradually feeds distilland into each bubble tube, as volatile-stripped distilland is withdrawn from the bottom of the bubble distribution chamber by another metering pump. Bubbles emerging from the top end of the bubble tubes, as at [74], are filled with stripping gas and saturated with distillate volatiles that were stripped from the distilland liquid feedstock and from suspended particulate solids, as the bubble made it's circuitous trip up from the bottom of the bubble tube. As bubbles collect on the surface of the distilland pool within the bubble-collapsing chamber as at [75], they continue to evaporate volatiles from the distilland pool, from the distilland bubble film into the free space above the bubbles, and from the bubble film into the interiors of the bubbles themselves, as shown at [76]. The distilland composing the liquid flux forming the matrix between the bubbles is constantly flowing downward between bubble films, to the surface of the pool of distilland below the bubbles. As the bubbles collapse in the chamber, they release their stripping gas and accumulated volatiles as shown at [77], which expand upward to the vacuum pipe at the top of the tower, whereas the distilland of the bubble film joins the downward flowing liquid flux.

Evaporation Surface Area: Each cumulative one-bubble layer of top plus side bubble films constitutes an addition of at least a 2× multiple of the undisturbed distilland pool surface area, which therefore functions as two more flat evaporation surfaces, evaporating volatiles out from both the inside and outside of every bubble film. It is common to have a 10-bubble or 20-bubble deep layer of bubbles above the distilland pool surface. Each 1-bubble layer then, at 2× per layer, constitutes a total 20× to 40× multiple of the pool evaporation surface area. When this is added to approximately a cumulative 5-bubble deep layer continuously present as rising bubbles throughout the liquid in each of the tubes and bubble distribution chamber, each with a 2× multiple, we have a total of 30× to 50× multiple of the flat pool evaporation surface area present at all times, and continuously being renewed from below with fresh bubbles.

Unlimited Film Surface Area: Whatever multiple the dynamic cumulative bubble film surface area may be in any particular size or design of tower, that evaporative surface area is being constantly renewed, by the continuous introduction of fresh stripping gas bubbles at the bottom. Surface area of the film then, is not a limiting factor for the change of state required to accomplish phase separation under any vacuum conditions. Often, the quantity of bubbles can be increased, and the distilland flow rate may be slowed, without altering vacuum conditions or heating conditions. With a continuously renewable evaporation surface, and continuously renewable method of cold temperature heating, it is clear that the degree of concentration to which the process can be carried is virtually unlimited, extending well beyond that of conventional methods.

One of these conventional examples, are plate-type juice concentrators which have a small high temperature evaporation surface area, and are viscosity limited, as they become clogged by viscosities greater than about 65% to 70% water reduction. Another example is the various spinning-cone column evaporator types, which are strictly limited to the cumulative evaporation surface area of both static and rotating cone upper surfaces. Spinning cone technologies are also viscosity limited by the gravity driven distilland flow rate across the angled static cone surfaces. The heating jackets on these evaporators have limited effectiveness, since most of the distilland travel time through the spinning cone unit is not in contact with the vertical wall sections of outer heating-jacket warmed surface. In addition, spinning cone columns cannot provide internal heating of the liquid, so they must pump the distilland out of the unit, and through a separate high temperature heater, external to the column. A third example, the “Centritherm” spinning cone column juice concentrator, is equipped with internally heated cones. Unfortunately, this device must have the aroma pre-stripped by another device (such as a large spinning cone column evaporator), and the Centritherm itself must use its internally heated cones at high temperatures to accomplish final concentration in a single pass, through the very limited surface area constituting the maximum two-cone sets of heated cones. The Centritherm is also viscosity limited by the angle of the static cones. In short, no conventional vacuum evaporation method has the virtually unlimited evaporation surface area enjoyed by the cold bubble method, or is less restricted by increasing viscosity.

Splash and Mist Arrestors: Turn now to “FIG. 10: Detail 3 of FIG. 4: Splash Arrestor and Mist Arrestor”. The stripping gas and volatiles released in the bubble-collapsing chamber by collapsed bubbles are shown by dotted lines as if on the way to the vacuum pump, as depicted at [78], but these gasses first encounter the splash arrestor disc [20] and mist arrestor media [21]. The gas and volatiles pass the splash arrestor unobstructed, by way of the heated through-holes of the splash arrestor, and quickly pass through the large open area, as depicted at [79], of the mist arrestor media. The purpose of the splash arrestor is to allow easy passage of the gas, and gas phase volatiles through the holes, but to form an effective barrier to passage of splashing liquid, as at [80], from the bubble-collapsing chamber, below. The surface of the shallow pool at the bottom of this chamber is often an extremely seething and roiling turbulent mass of bubbles and liquid, with frequent spurts and eruptions of bubbles from below. The holes in the disc divert any blobs of liquid or slush with ice crystals that might be projected with enough force to reach this splash arrestor, preventing such material from being projected up into the vacuum pipe. The splash arrestor disc itself is heated by fluid pumped through it's heating jacket (by way of pipe at [23], so accumulated liquid that splashes through, into, or onto the bottom of the disk as at [81], will not gradually freeze, but will drip down into the pool below. Even liquid that splashes on to the inner surface of the holes, or completely through the holes, to drop back down onto the top of the disc, will experience melting of any ice crystals it may contain, and the distilland will drip down.

The optional layer of mist arrestor media is intended to strip any minute droplets of distilland from the molecular gases if these droplets have escaped the splash arrestor disc, eventually allowing the droplets to accumulate and drip down through the splash arrestor, to the liquid pool below. Large pore plastic reticulated foam works well at warmer temperatures, and is easily held in place by supports, such as at [82]. If continuous near-freezing operation for long periods of time results in an unacceptable level of blockage by ice crystals, this foam can be constructed of copper reticulated foam, and cored for placement of silver-soldered heating tubes and tube manifolds.

The entire metal reticulated foam/tube assembly can be Nickel-plated for FDA acceptability. The assembly, with heating tube input and output manifolds at the two sides of the foam (not shown) can be supported and serviced by flexible pipes connected directly to the heating fluid delivery and return pipes passing through the dome at the top of the tower. A simpler alternate solution, if some form of mist arrestor is needed, is to fabricate plugs or disks of reticulated foam in Nickel-plated copper, sized to fit snugly into the through-holes of the splash arrestor. They can be pressed into the ˜1.5″ diameter holes manually, wherein, complete circumferential contact with the heated tube walls will provide enough heat from thermal conductivity, to prevent ice crystals from forming and blocking the holes. Another alternate solution is to form a deep basket of unheated plastic reticulated foam to cover and extend down from the pipe opening, which will sit in that space where no projected distilland drops can reach. Such a basket will not re-melt ice in collected distilland mist droplets, but simply hold and evaporate the accumulating droplets forging a sticky paste within the foam mesh until clean-out. The three mist-handling solutions are provided here as a contingency, but for food applications and most other applications, the optional “froth and mist centrifuge”, described below, would be used in place of both the splash and mist arrestors.

A plan view of the splash arrestor, “FIG. 6: Section E-E of FIG. 1: Splash Arrestor Disc, Through-Hole Pattern”, indicates a placement pattern for the through-holes (note that all holes are not shown). Please note that the straight walled through-holes will interrupt any liquid projected up through the holes, except for a trajectory of about zero to 8 degrees. Since the large vacuum pipe superimposed here at 8″ diameter, as [83], is located directly above the blanked-out center section of this disc where there are no through-holes zone shown at [84], no distilland drops can be projected into the vacuum pipe. It is important that liquid not be splashed or projected into the vacuum pipe from the bubble-collapsing chamber, as this may necessitate a lengthy clean-up process under some conditions. These pass-through holes present no obstruction to molecular gasses, but the very few splashing distilland drops which reach this location above the pool, and do not have an elevation and trajectory that coincides with one of the through-hole, openings are arrested by the walls of the through holes or bottom surface of the splash arrestor disk.

Less than 40% of all projected distilland drops will reach an open hole in the arrestor disk rather than a solid surface; of which projected drops, less than 5% entering the through-holes are at an angle that can achieve passage through the arrestor disc through-holes; of which less than 1% might have the elevation providing enough force to reach the top of the tower; which is a total of about two drops per 10,000. All other projected drops fall back into the bubble mass, or fall upon the walls of the bubble-collapsing chamber, the disk, or the through-holes, and drip back into the bubble-collapsing chamber. If the temperature of the arrested drop of juice is cold enough that the drop contains ice crystals or forms ice through evaporation, the ice is melted by heat from the disc jacket or chamber wall, so a gradual build up of frost and ice slush will not slowly build up blockages in the disc through-holes. This detail assures that there will not be an icy buildup to retard stripping gas flow to any degree detrimental to efficient vacuum evaporation.

Forming Bubble Tubes: The configuration of the bubble tubes themselves plays a vital role in tower performance, so care must be taken in the important process of forming the tubes. In FIGS. 3, 4, 8, & 9, the turbulators are indicated schematically as half-circles, but in reality these perturbations in the tube wall are carefully detailed, and must be formed with precision. Seamless, thin walled, compliant (annealed), food grade stainless steels should be used (such as 316SS). The tubes are to be pre-packed and vibrated tight for maximum fill with a fine-to-medium grade of solid glass beads, such as is used in bead-blast machines. This packing will provide repeatability in approximating the effect of matched metal die tooling as the tube is reformed. The turbulator configurations are formed of the tube walls by pressing the glass bead packed tube within a two-piece metal die, which has: (A)—a forward section for holding one end of the un-pressed tube in true alignment during press-forming of the tube; (B)—a center section which press-forms turbulators into the tube on a first side of the tube, and simultaneously press-forms alternating turbulators into the tube on a second opposite side of the tube; and (C)—a following section for holding the other end of un-pressed tube in true alignment during press-forming of the tube. The process of pressing turbulators into the tubes will stretch the metal at each turbulator site, and depending upon desired turbulator shape, may also elongate the metal on the backside of the turbulators to some degree. A tube pre-heating station can be built into the tool for pre-heating the turbulator locations on both sides if necessary, immediately prior to pressing, especially for deeper turbulator configurations. A straight unheated section should be left at both ends of each tube, to be placed in the forward and following sections during tube press forming, and the tube cut to size after forming is complete. The tube ends must retain its original straightness and roundness, so that it can be inserted and welded into the tube end plates. If tube length is short enough, say four or five feet long, individual tubes can probably be press formed in their entirety at one time with a single die-set, but it may be more economical to press longer tubes using multiple strikes of the same dye-set.

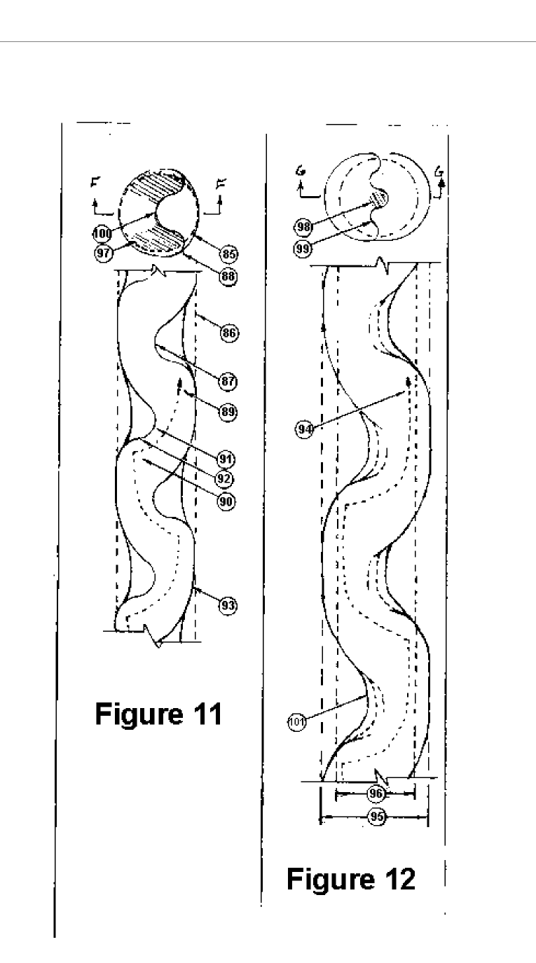

Bubble Tube Turbulators: Turning to the bubble tube drawings, FIG. 111 and FIG. 12, two representative types of bubble tube turbulators are illustrated. In “FIG. 11: Simple Turbulator” we see a bubble tube cross section with turbulators that require tube reforming only at the sides and front of each turbulator location. The backside of each turbulator stays within the original cylindrical tubing dimensions. FIG. 11 shows broken line indications of the original cylindrical tube shape, as at [85] and [86]. In this example, the turbulators depth extends halfway into the tube diameter, as at [87], and extend tube width at both sides of the turbulator, as at [88]. Please note that the turbulator shape causes the path of rising bubbles, indicated by the broken line at [89], to repeatedly change direction and to momentarily pause, when each bubble first impacts the next turbulator in succession, as at [90]. The turbulator shape causes each bubble to articulate or elongate and bend around the turbulator tips, scrubbing past the extended and optionally scalloped edge as at [91] which also rakes the passing bubble gas, heating the gas and mixing the gas through aspiration of gas from one section of an elongated articulated bubble to another, as the bubble articulates around scalloped turbulator tips. Bubbles also impact against and scrub across the underside as at [92], of each turbulator, while larger bubbles scrub against the turbulator backside, as at [93], of the narrower tube passageway, when squeezing past the tip of the turbulator.

These induced bubble activities cause: increased bubble path length and reduced bubble rise speed, both of which result in increased bubble residence time. Turbulators cause bubbles to follow a mandatory, articulated, torturous path for rising bubbles, aggressively scrubbing distillate from the distilland, and forcing mixing-in of the hottest liquid scrubbed from direct contact with the tube walls, with colder liquid from the middle of the tube to increase evaporation efficiency. Bubbles undergo aggressive three-dimensional flattening with elongation, and articulating or bending around turbulator tips, and undergo corrugated distortion of the bubble and gas volume within the bubble, and thus, mixing of warm and cold zones within the otherwise still bubble gas itself, which would normally remain stratified circumferentially or horizontally into warmer and cooler enclosed bubble gas zones constituting greater and lesser volatile-saturated bubble gas. All these activities contribute to more turbulence in the rising bubble gas, and more turbulence in the processed liquid as it moves down the bubble tube. The result of all this induced bubble activity is more efficient volatile stripping. While the turbulators need to be self-draining to shed liquids during flushing or CIP cleaning (no cross-sectional undercuts that form liquid holding pockets after draining can be tolerated), there are numerous simple and complex variations on the turbulator shape, each of which will have certain advantages for specific applications. Certain applications may call for or tolerate turbulators that are not integrally formed, but are created using other conventional means. Turbulators may be molded of rubber or plastic, stamped or cast, and then spot welded or mechanically attached with O-rings or a gasket; or for non-food applications such as essence or chemical separations, they may be snapped in place using deformable turbulators, or with spring-loaded members or clips, etc., as the application requirements will allow. Even the simple alternating placement of the turbulators along the tube has many variations, such as alternating front and back with left and right, or spiraling pairs or groups of pairs around the tube, or the tube can be oval, rectangular, or square, etc. The turbulator descriptions and depictions provided here are not intended to be definitive, but intended rather, to merely indicate the nearly endless variety of legitimate turbulator configurations possible for those skilled in the art, to adapt the exact tube or tubular design for whatever features best meet the particular product needs.

In “FIG. 12: More Complex Turbulator” we have one example of a bubble tube that starts with the same diameter of tubing used in FIG. 11, but while the turbulators are being pressed, the backside is also being reformed in the process. In this case we may wish to preheat front, back, and or sides of the whole die-set turbulator section of tubing before pressing. When comparing this tube with the simpler tube in FIG. 11, this tube design has all the features of the simpler tube design, but this more complex bubble tube also provides four new advantages: deeper turbulators and backside tube setback, for a longer bubble path length [94] for rising bubbles (the reformed tube width at [95] is 38% greater than the original tube width at [96]; elimination of the two open areas, such as the shaded area in FIG. 11 at [97], where smaller bubbles can rise straight up and not encounter the turbulators, (exception is area in FIG. 12 shown as [98] which is intentionally left open for passage of the core of a cleaning brush or pressure wash-out tube); the scalloped front edge of the turbulator [99], which causes more aggressive heat scrubbing than smooth front edge [100] in FIG. 11; and finally, a more open shape on the heating fluid side of the turbulators, as at [101], which allows greater access to heating fluid, for a more uniform heat distribution.

Bubble Tube Sections: There are numerous possibilities for attaching the bubble tubes to top plate [59] and bottom plate [57] illustrated in FIG. 3, and no attempt to cover the broad range of methods will be made. The simplest solution is to weld the tubes into both the top and bottom plates, expanding the tube into a shallow circumferential groove in the plate hole to which each tube is welded, as is conventionally done with heat exchangers. Now the complete tube section can be changed out should tube size need to be increased or decreased. As they relate to bubble tubes, the Tower performance requirements to be met include: 1—Operation at the full thermal range of potential products, from ˜30 F degrees for juice concentrates, to over 300 F degrees for some chemical separations. 2—Full drainage of the processed product must be incorporated, without any non-drainable pockets, in order to satisfy FDA requirements. 3—Tubes must be CIP capable. 4—Tube sections need to be sturdy, and equipped with lift points and design details that allow for simple exchange of these sections, so that tube sections having different turbulator designs or different tube diameters, can be swapped out by a two-man crew in a couple of hours.

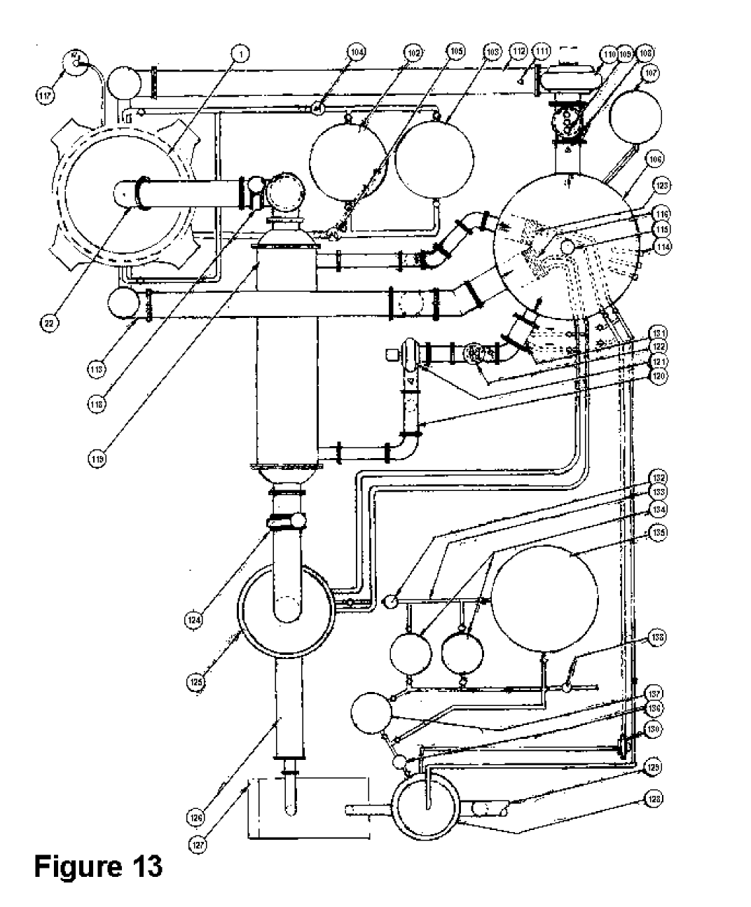

Cold Bubble Volatile Stripper with Condenser: Turning to “FIG. 13: Cold Bubble Volatile Stripper with Condenser, Plan View”, we see typical support equipment installed with the tower, utilizing a condenser for volatile capture. This system strips the volatiles at low temperature so as not to do any damage to the concentrate, and immediately prior to entering the condenser, momentarily warms the volatiles up just enough for volatile capture. This approach strips volatiles at freezing temperature, and then briefly (a few seconds) achieves a higher volatiles temperature in a heat exchanger prior to entering the condenser. This novel method fully protects the distilland from nutrient-damaging heat during evaporation, and briefly warms the volatiles just enough for effective capture. Please note that the heated-volatile temperature is independent, and can be varied experimentally to determine optimum temperature for flavor quality and volatile capture efficiency with each respective distillate. The heat exchanger can also be unheated, for products which do not need this, such as brewed coffee or tea flavor extractions.

The tower itself is shown at [1]. Since many distillands will need to go through the tower at least twice; first to strip volatiles (flavor essence), and then to strip water, we will have two chilled holding tanks with agitators for the distilland, as shown at [102] and [103]. A typical process would have distilland liquid or slurry for example, going through metering pump [104] from full tank [202] into the top of tower [1]. The distilland is stripped of essence volatiles in the tower, and then pumped out the bottom of tower [1] through metering drain pump [105] into empty tank [103]. In a second pass, the distilland is pumped from now full tank [103] into tower [1], becomes concentrated in the tower as water is stripped, and concentrate is gradually removed from the bottom of the tower by pump [105] into now empty tank [102]. The water stripping operation may be completed with the second pass through the tower, or might be repeated, in a third pass for example, using different processing parameters for still higher concentrations.

Most food distillands are extremely susceptible to oxygen degradation, so these processing tanks will be topped off with an inert gas, such as Nitrogen, which will be continuously replenished when liquid is withdrawn from the tank. Thus an emptied tank will be filled with Nitrogen, ready for the next food distilland to be processed. In the case of these two processing tanks, “Nitrogen sharing” between the tanks will help minimize Nitrogen gas waste. Thus the distilland withdrawn from one tank is refilling the other tank, and the Nitrogen being vented from the filling tank will be piped to the emptying tank as the liquid level drops. Only net volume reductions require adding additional nitrogen.

Typical food distilland heating temperatures are: ˜45 to ˜60 degrees F. for aroma recovery, and ˜60 to ˜75 degrees F. for concentration (water stripping). Typical vacuum pressures used are ˜100 um to ˜24″ Hg, but some processes can be run at ambient pressure by venting the condenser output pipe [126] and shutting off the screw compressor. Stripping gas used at ambient pressure can be any inert gas, or vacuum steam, generated by some processes. In conditions of low temperature processing, such as fruit or vegetable juices or slurries, processing time can be extended if desired, without damage to flavor or nutrition. This is possible because the liquids are not exposed to heat damage in the process, and liquid flow rate through the tower (speed of metering pump [105]), which is completely independent, determines processing time.

Fluid Heating System: In FIG. 13, the heating fluid (such as water/antifreeze mixtures using conventional materials, such as propylene glycol for example) is held in thermal fluid storage tank [106], supported by vented thermal fluid expansion tank [107]. The fluid may be preheated if desired, using heating elements such as Watlow single-ended “Firebar” 1-inch screw-plug, flat tubular immersion heaters shown at [114], and using circulation motor [115]. During processing, heated fluid is drawn out of tank [106] past thermocouple [108] and past heating elements as at [109] by centrifugal pump [110], and fed into the tower through heating fluid delivery pipe [112]. Thermocouple [108] is used to determine temperature of the fluid coming from the tank, and elements such as at [109] are used to heat the fluid “on-the-fly” (as the fluid flows past the elements and on its way to the pump), up to the required processing temperature. The heated fluid becomes thoroughly mixed by centrifugal pump [10], and then thermocouple [111] feeds back a uniform heated fluid temperature that is used to control elements [109]. From this description we can see that the temperature of heating fluid then, can be quickly heated to nearly any required processing temperature above storage tank temperature. Heated fluid passes from delivery pipe [112] into tower [1] where typically low temperature heat is transferred to the distilland, as shown previously in descriptions of the stripping tower.

The cooled heating fluid emerging from each of the tower heating jackets, and then gathered into the heating fluid collection pipe, is passed to heating fluid return pipe [113] on it's way back to the bottom of tank [106], where the returning fluid is projected through a submersible heat exchanger at [116], positioned within the tank in front of the returning fluid stream as shown.

Volatile Evaporation: In FIG. 13, Nitrogen gas (or other inert or reactive application appropriate gas) for bubbles is fed into tower [1] from tank [117]. Under higher vacuum pressures such as for water stripping, very little gas volume is needed to provide copious amounts of bubbles to tower [1]. The bubbles perform the stripping function, as described previously at FIG. 8 and FIG. 9, and stripped volatiles plus the feed gas exit tower through vacuum pipe [22]. The stripped volatiles and gas pass through throttle gate valve [118], used to regulate vacuum pressure in the tower. The cold-stripped volatiles from the tower enter heat exchanger [119] where the stripped volatiles are warmed by countercurrent thermal fluid, circulating through the heat exchanger. This fluid from tank [106]0 is fed into pipe [120] by pump [121], is heated by a similar bank of heating elements at [122] with input and output thermocouples, as is used at [109] to heat the tower. Fluid returning to tank [106] from the fluid return pipe of the heat exchanger [119] is projected through submersible heat exchanger [123] positioned within the tank in front of the returning fluid stream.

Condensers: Volatiles exiting the heat exchanger [119] in FIG. 13 pass through another throttle gate valve [124]. Subsequently the heated volatiles enter refrigerated condenser [125] (or a condenser with external chilling tower), where almost all of the volatiles are removed from the gas stream. The stripped gas stream continues on through pipe [126] to the dry screw vacuum pump [127], after which any remaining volatiles are easily stripped from the gas stream in condenser [128], as a result of the high temperature achieved when passing through the pump. Only the stripping gas remains to be exhausted at pipe [129], and this is recycled back to tower [1], to be used instead of tank [117]. The Freon-type cooling fluid for refrigerated condenser [125] will be hot, and will use submersible heat exchanger [116] positioned within tank [106]. Tank [106] is frequently kept at low temperatures, so when the chiller fluid is too hot for tank [106], this hot fluid can be diverted to the heating fluid going to the small heat exchanger at [131]. Introducing this hot fluid upstream from the heating elements [122] will greatly reduce power requirements for these elements. Centrifugal pump [130], used to circulate the cooling fluid for condenser [128] will also be delivering higher temperature fluid to tank [106], so this fluid may also be diverted to the heat exchanger used for warming feed line heating fluid at [131], delivered to the large heat exchanger. An alternate efficiency is to circulate the cooling fluid from one or both of these two condensers to another small heat exchanger (not shown) positioned upstream from the tower heating elements at [109], such as is shown at [131].

Condensed Volatiles: The cold-stripped flavor volatiles extracted in the first pass of any food liquid through tower [1] when making concentrate, contain the highly important and valuable flavor and aroma top notes. These volatiles, captured in condenser [125], are withdrawn by pump [132] into pipe [133] and stored in tank shown at [134], for later blending with the concentrate. Any volatiles that escape condenser [125], are captured in condenser [128], but have suffered some heat damage from passing through vacuum pump [127]. These hot-stripped volatiles are withdrawn from condenser [128] by pump [136] and stored in tank [137]. During the subsequent water-stripping pass or passes for concentrating juice, the captured water is removed from both condensers, by either pump [132] or [136], directly to extracted water storage tank [135]. Pump [138] is used to drain the contents of any distillate storage tank.

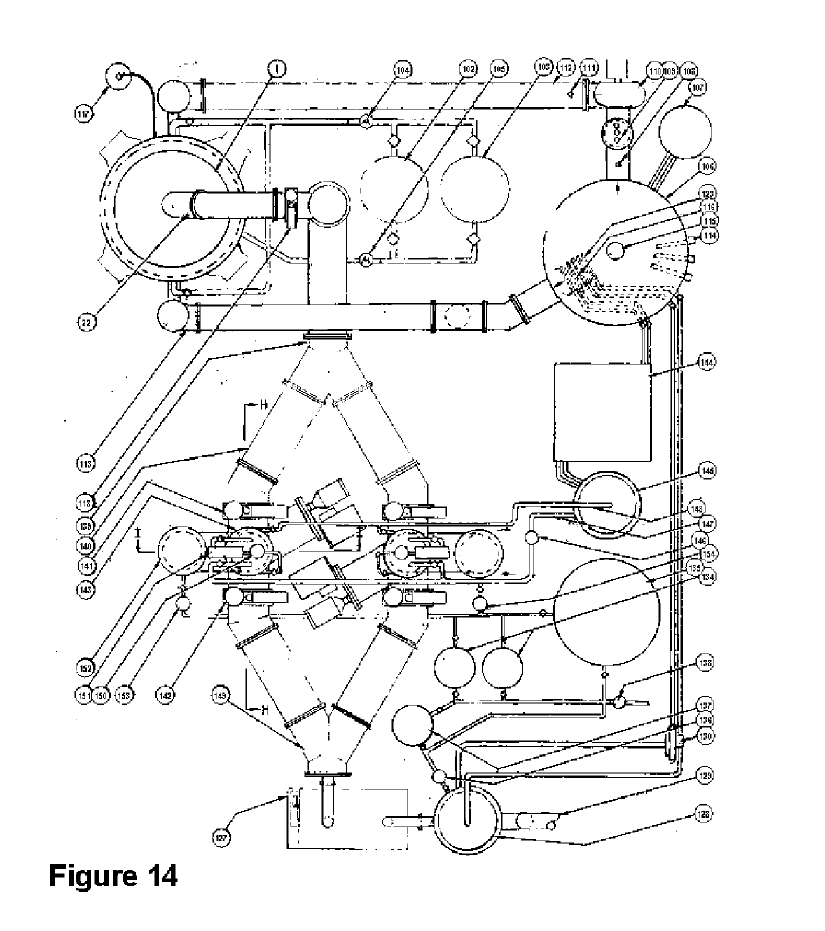

Cold Bubble Volatile Stripper with Freeze-Condenser: Turning now to “FIG. 14: Cold Bubble Volatile Stripper with Freeze-Condenser, Plan View”, we can see that it is very similar to FIG. 13, and many components are in fact identical. The difference is that FIG. 14 uses an alternative method for volatile capture, and most other components will stay the same. FIG. 13 takes volatiles at near-freezing, or even sub-freezing temperatures which will be emerging from the stripping tower, and momentarily warms these cold molecules to a minimum temperature in a heat exchanger, so that the condenser is able to capture volatiles in liquid phase. But in the case of near-freezing volatiles so delicate that no heating can be tolerated, some method besides a conventional condenser must be used. The present invention provides a unique “freeze-condenser” method for performing this function, as shown in FIG. 14.

Cold Bubble Tower and Heating System: In FIG. 14, we see the same cold bubble tower, processing tanks, and thermal fluid storage tank, which all operate the same way as in FIG. 13. The same thermal fluid is withdrawn from tank [106] and heated by elements [109], using thermocouples [108] and [111] to regulate those elements. Centrifugal pump [110] circulates the thermal fluid through pipe [112] to the heating jackets in tower [1], and back through pipe [113] to tank [106]. Tanks [102] and [103] are used to pass the food liquid through tower [1] using valves [104] and [105], as before. Inert gas from tank [117] feeds gas to the bottom of tower [1], which strips volatiles in the same way as in FIG. 13, and the stripping gas with the cold-stripped volatiles exits the tower under vacuum at vacuum pipe [22] to pass through valve [118]. But at this point, the gas and stripped volatiles enter a completely different device, one employing a new method of capturing the volatiles, by means of freezing.

Duplicate Freeze-Condensers: Upon entering the “double vee” vacuum device at [139], the carrier gas and volatiles will move down the open side of the vee; only one side of either the left or the right side of identical alternative vacuum routes will be opened. Only one of these two vacuum routes, both equipped with a freeze-condenser, will be open through to the vacuum pump, whereas the other side will be closed. In the case where the left side is open, both of the three-position gate valves [141] and [142] will be open, while the identical two valves on the right side will be closed. With these left side valves open, the gas stream flows through valve [141] and into left-side freeze-condenser [143], where most of the volatiles are stripped from the passing gas stream by freezing. The sub-freezing temperature is achieved by chiller [144], which discharges the collected heat in a submersible heat exchanger shown at [116] within tank [106]. The chiller uses heat exchanger [145] to keep a recirculating quantity of fluid, pumped at [146] through pipes [148] and [147], at freezing temperatures. Pipes [148] and [147] deliver the freezing fluid to both the left and right freeze-condensers, as shown. The stripped gas and any escaping volatiles will continue on out of freeze-condenser [143], to pass through valve [142] and then down through the downstream double-vee vacuum pipe to [149], where the left and right sides of the vee join together again, and then continue on to the dry screw vacuum pump [127]. Any volatiles escaping capture in freeze-condenser [143], are still remaining in the gas stream, and will be heated briefly but excessively in vacuum pump [127], before entering condenser [128]. As in FIG. [13], those remaining volatiles are stripped by condenser [128], while the carrier gas is exhausted at [129] for recycling back to tower [1], to conserve the gas in tank [117].

Back in freeze-condenser [143], the volatile ice builds up to a maximum degree, determined by the pressure differential measured upstream and downstream from freeze-condenser [143], at which time the ice is to be removed. The two valves [141] and [142] will be closed, but the corresponding two gate valves on the right side must be opened first, to provide an uninterrupted flow of volatiles through the right side freeze-condenser, and to the vacuum pump.

Frozen Volatiles: Frozen volatiles are removed from the freeze-condenser by melting the ice touching metal surfaces. This is accomplished by closing valves that isolate the thermal liquid residing in the freeze-condenser, and recirculating the isolated fluid using pump [150] through a closed-loop heating cycle with heating element [151]. This process will allow the captured volatiles to be moved to melt chamber [152], where the volatiles are melted, and subsequently moved by melt pump [153] to cold-stripped distillate storage tanks [134] for cold-stripped flavor. We alternately performing this process, first on this left side, and then on the right side, using identical equipment, wherein we have pump [154] to move the volatiles from the right side apparatus to storage tanks [134]. More of the same equipment seen in FIG. 13 can again be seen here: from condenser [128], the hot stripped flavor is moved to storage tank [137], or the hot stripped water is moved to tank [135] by pump [136]; the thermal fluid used to cool condenser [128] is circulated by centrifugal pump [130] to submersible heat exchanger [123] in tank [106]; stripped water is moved by pumps [153] and [154] to storage tank [135]; and the stripped flavor from any of the flavor storage tanks [137], tanks [134], is moved by metering drain pump [138] and taken for blending with the concentrate, or blending with the stripped water in tank [135], or to be stored for some other use.

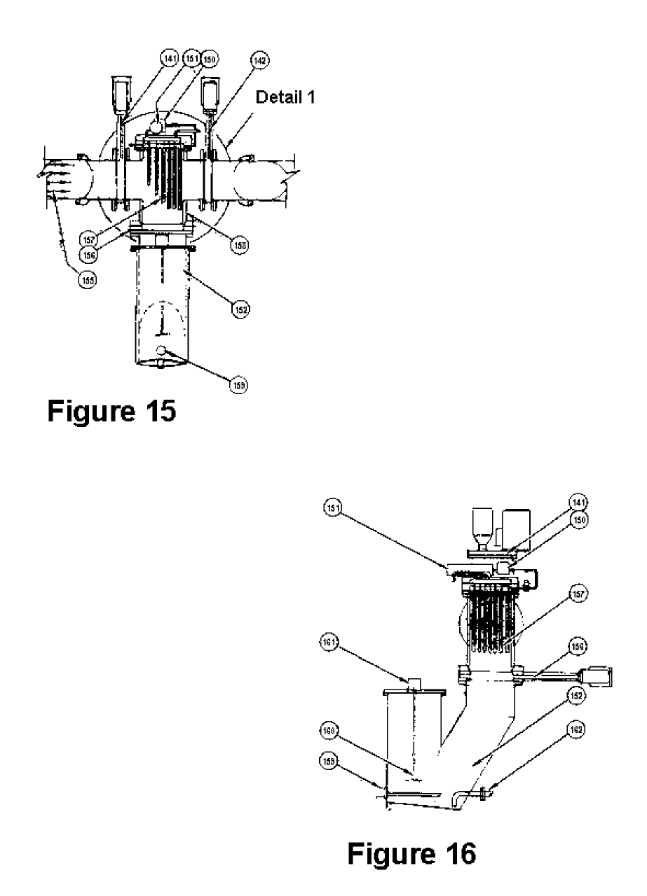

Freeze-Condenser: The present invention provides both the method described above, for capturing volatiles at below-freezing temperatures, and a non-mechanical method for stripping the volatile ice from the freezing surfaces. Both methods are performed with no moving parts except for valves. To better explain operation of the Freeze-Condenser, please turn to FIG. 15: “Section H-H of FIG. 14; Freeze-Condenser Linear Section”. In FIG. 15, we have a group of arrows as shown at [155] indicating the direction that gas and volatiles are moving through the vacuum system from the cold bubble stripping tower [1]. The lower three-position gate valve is closed at [156], while gate valves [141] and [142] are shown open, to allow the vacuum system to pass through this freeze-condenser. The individual freeze tubes are shown, as at [157], used to freeze volatiles out of the passing gas stream, onto the exterior of the tubes. When the freeze tubes are ready to be stripped of the accumulated volatile ice, first the opposite side gate valves, corresponding to valves [141] and [142] but on the opposite side of the vee, are opened. This allows uninterrupted operation of volatile stripping to continue on the opposite side of the vee, during the thaw cycle of this freeze-condenser. Then, gate valves [141] and [142] are closed and gate valve [156] is opened, which completely isolates this freeze-condenser from the remainder of the vacuum system, and gives access to the melt chamber [152], below. Next, flow valves isolate the thermal fluid in this freeze-condenser, and pump [150] moves the isolated fluid through heater [151], and down to this array of freeze tubes. The now heated fluid melts the volatile ice where it is in direct contact with all freeze tubes. An inner jacket containing heating elements surrounds the freeze tube array as at [158] which will melt any ice bridging the tube array and contacting the surrounding jacketed walls. When all metal surfaces in contact with the ice have melted the contacting ice surface, there is nothing holding the ice up around the tubes, and gravity will strip the ice, whereupon the ice will drop down through open gate valve [156] into melt chamber [152].

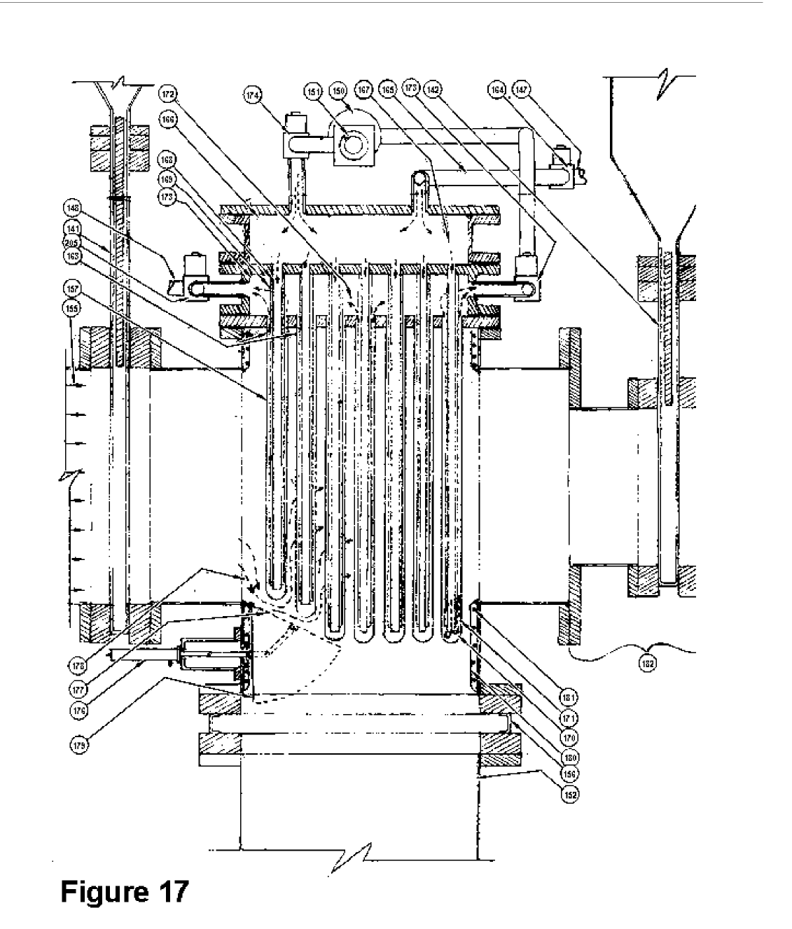

Melt Chamber: A side view of the melt chamber is shown in FIG. 16: “Section I-I of FIG. 14; Freeze-Condenser Axial Section”. The gate valve depicted at [141] is closed when gate valve shown at [156] is in open position, as shown. Circulating pump [150], and enclosed heating element [151] are shown, for circulating heated fluid for melting accumulated distilland ice. After the ice falls down into the melt chamber [152] (as described in FIG. 15), gate valve [156] will be closed. With all ice now stripped from the freeze tube array, the upstream vertical gate valve shown at [141] (and in FIG. 14) will be opened. Looking again at FIG. 14, any drips or splashes remaining on or around the freeze tubes will be quickly scavenged by the ongoing vacuum flowing through the vee on the right-side, as we again start freezing fluid flowing to this left-side freeze-condenser through pipes [148] and [147] shown in FIG. 14. Any remaining volatile drips on this freeze-condenser, now under vacuum, will vaporize and flow backward up pipe [140] and [139] to where this left-side of the vee joins with the right-side vee, and these volatiles will join the flowing gas and volatiles down the right-side of the vee, to be captured in the right-side freeze-condenser. Returning to FIGS. 15 and 16 of the left-side vee, within less than one minute under vacuum again, any volatile drips will have evaporated and the freeze tubes will be approaching freezing temperature again. Then valve [142] may be reopened to start the vacuum flowing through this freshly stripped freeze-condenser again, and the freeze-condenser on the other side of the vee may then be isolated, to start the ice-stripping cycle for the right-side of the vee. Meanwhile, back in FIG. [16], the stripped ice within melt chamber [152], isolated from the vacuum system by gate valve [156], is being melted by heating element [159]. When the liquid level gets deep enough, agitator [160], driven by motor [161] will help break up and circulate the ice pieces, accelerating the ice melting process. The melted volatiles will be pumped out of the melt chamber through pipe [162] by the pump shown in FIG. 14 at [153]. To conserve energy, heating element [159] can be substituted with a heat exchanging coil from the hot side of the chiller (show at [144] in FIG. 14) or from the hot-stripped flavor condenser cooling fluid (shown at [128] in FIG. 14), basically diverting some or all of that cooling function to this ice melting task at the bottom of melt chamber [152]. The tube array, shown as “Detail 1”, is described in FIG. 17. Diverting some or all of the hot fluid from the submersible heat exchangers [116] or [123] in FIG. 14, will increase overall efficiency, provided the heat from [16] or [34] is not needed to warm the fluid in tank [106].

Freeze-Condenser Tube Array: Turn now to FIG. 17: “Detail 1 of FIG. 15: Freeze-Condenser Tube Array”. We see the arrows coming in from the left at [155], which indicate the flow direction of expanding cold gas and volatiles from the tower, about to enter the upstream gate valve [141]. As these gasses sweep through the vacuum system, they pass through open valve [141] and impinge upon the array of tubes such as shown at [163], protruding into the path these gasses must take on their way to the dry screw vacuum pump. As the distillate volatile molecules accompany stripping gasses that ricochet through this maze of tubes, the volatiles adhere to the outer tube surfaces, as at [157], simply due to the below-freezing temperature of the tubes. The effect then, is a stripping, or filtering out of the distillate volatiles from amongst the carrier gas molecules that will continue on to the vacuum pump.

Referring briefly to FIG. 14, please note that chiller [144] is enabling the fluid passing through heat exchanger [145], to achieve sub-freezing temperatures, then this sub-freezing thermal fluid is circulated in pipes [148] and [147], to both the left and right side freeze-condensers, such as [143], which concerns us in FIG. 17. Again in FIG. 17, we see that the freezing fluid arriving from the chiller/heat exchanger from feed pipe [147] will enter open feed solenoid [164] (valve [174] being closed), which conducts the fluid through pipe [165], to feed manifold [166]. From the feed manifold, freezing fluid enters the open end of all tubes in the array, such as at [167]. Fluid is conducted down through all these inner tubes, as at [168], which is encased with a snug-fitting outer thermal insulation sleeve, as at [169] to preserve the freezing temperature of the downward flowing fluid. The fluid thus passes down the entire length of all inner tubes, emerging from the bottom open end of each inner tube, only to immediately reverse direction, as shown at [170]. The fluid then flows upward in the gap all around between the inner tube's insulation layer, and the outermost tube wall, as shown at [171], to perform the function of absorbing heat from the outer tube walls, and thus chilling these outer tubes to the degree that volatiles freeze upon their outermost surfaces. This fluid is warmed during it's upward flowing path, until the fluid from all tubes exits these gaps as at [172], between the inner and outer walls of all pairs of these tubes, and fills the return manifold shown at [173]. The fluid then passes from return manifold [173] through open return solenoid valve [205] (valve [175] being closed), and begins its return to the chiller/heat exchanger, through return pipe [148].

As ice builds up on the leading surfaces of front tubes, the ice will begin to block the flow of the gas phase distilland volatiles and stripping gas, as the gasses pass between these elements of the tube array. Cylinder [176] will be holding gas flow restrictor flap [177] in its upward starting position as shown here, and the volatiles and gas will increasingly be flowing under the front rows of shortened tubes, occurring between the top of flap [177] and the bottom ends of the front rows of these shortened tubes, to take a path of less resistance to the vacuum pump, as shown at [178]. As the gas flow routes under the front rows of elements also become progressively more blocked, eventually the spaces between front rows and middle rows of tubes will also become blocked enough with ice, even as most of the gas flow is passing under the blocked front rows of tube elements. Eventually a predetermined pressure differential is detected from vacuum sensors located both upstream and downstream from the tube array, which indicates an inefficient level of blockage. At this point, cylinder [176] will move the flap [177] to position [179], allowing the gas flow to bypass the blocked rows of elements by flowing under them, to be drawn up between the unblocked back rows of tubes to deposit the burden of volatile molecules in the largely open spaces between these more downstream array elements. Eventually, when the vacuum differential indicates unacceptable blockage between back rows of tubes, it is time to remove the ice.

Ice Removal: Ice removal first requires verification that the alternate, or right side freeze-condenser, located on the other side of the vee to have completed its thaw cycle, and to have begun actively stripping volatiles again, assuring uninterrupted stripping operation. Then, these left-side solenoids [164] and [174] are closed, to isolate this freeze-condenser from the chiller/heat exchanger equipment, and solenoids [205] and [175] are opened in preparation for the recirculated-fluid thaw cycle to begin. Pump [150] is activated to recirculate the fluid, and enclosed heating coil [151] begins cycling on and off, to main a preset fluid temperature used for the thaw cycle. As the temperature in entry chamber [166] begins to rise, gate valves [141] and [142] are closed, isolating this left-side freeze-condenser from the vacuum system (valves [141] and [142] will actually be the same size, but valve [142] is shown smaller, as is appropriate to use with an optional 8″ pipe system which is shown at [182], for purposes of comparison). The bottom gate valve [156] may now be opened, which will release partial pressure into the freeze-condenser space from the melt chamber. Warm stripped gas (from the vacuum exhaust at [129] of FIG. 14) may be added up to ambient pressures.

As the inside of the freeze tubes get warm, the ice will melt everywhere the ice is in contact with the freeze tubes. The vertical vacuum housing surrounding the freeze tubes is lined with a sheet metal heating shroud, as at [180]. Behind the shroud are the shroud-heating elements, as at [181], which are used to warm up shroud surfaces which might be in contact with the build up of ice. When the ice in contact with all metal surfaces has been melted, the ice will be gravity stripped, dropping down into the melt chamber [152]. Optical sensor beams projected across the vacuum chamber between tubes will be used to detect that the ice has dropped off the tubes, indicating that the thaw cycle is finished. At that point, heating elements as at [181], and heating coil [151] are turned off. Pump [150] is turned off and valves [174] and [175] are closed, while valves [164] and [205] are opened again. Gate valve [156] is closed, and gate valve [141] is opened again, subjecting this tube array to vacuum conditions once more, and the flap is returned to the up-position [177]. The vacuum will scavenge any drops of volatiles remaining on the tubes, backwards through the vee, where these drops will be collected on the right-side array, as these left-side tubes again are chilled to below-freezing temperatures. At that point, this left-side array is ready to go back into volatile-collection service again, and gate valve [142] is opened, to begin the flow of volatiles across the cleaned tubes. Now the right-side freeze-condenser array on the other side of the vee may be closed off, to go through its thaw cycle for stripping collected ice from the right-side freeze-condenser tubes.

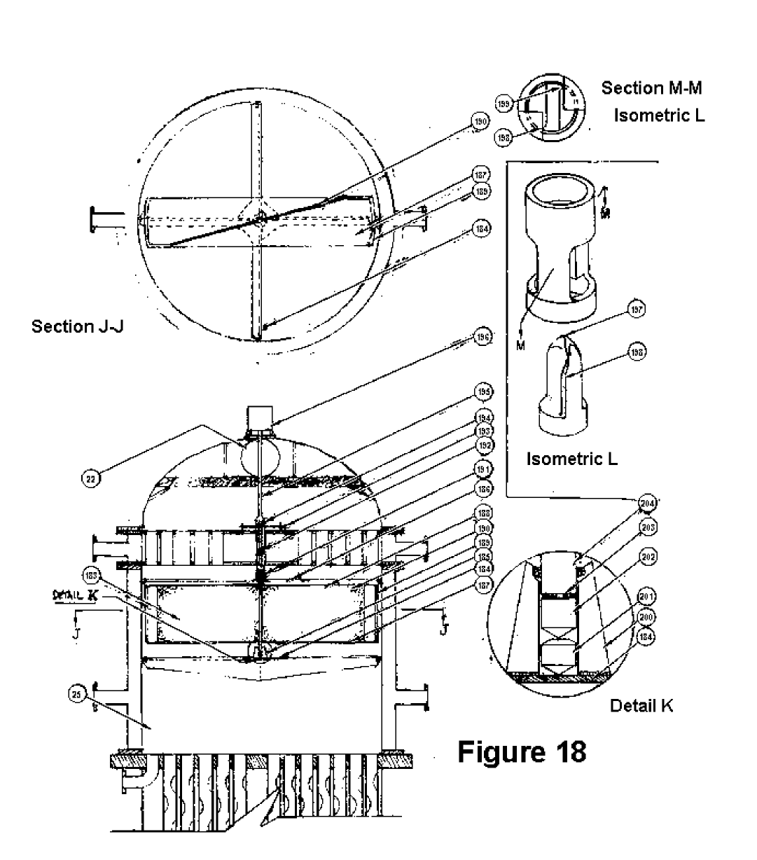

Froth and Mist Centrifuge: Turning to FIG. 18: “Froth & Mist Centrifuge” and “Section J-J”, we may consider a generic example of this Continuous Flow Centrifuge. Not all products and processes will necessarily have a need for this component. In cases where there is the possibility of a very rapid buildup of bubbles in the bubble collapsing chamber [25], to the degree that the bubbles might fill the vacuum system and expand into vacuum pipe [22] at the top of the tower before corrective action can be taken, the froth and mist centrifuge [183] can quickly stop all bubbles from expanding past the centrifuge. This component is located downstream (in the gas stream flow) from the bubble expansion chamber, as shown. Its primary characteristic is the ability to submit a continuously flowing stream of gas (or liquid for that matter) to centrifugal removal of particulate that is suspended in the flowing stream. The centrifuge may run all the time during processing, or only if triggered by a sensor. For example, where bubbles expand to the point that they could trigger a sensor-beam activated switch with the beam positioned just below the centrifuge; at this moment the centrifuge might be automatically activated. The rotating centrifuge will scoop up any foam and bubbles right along with the gases, as they expand up into the rotational path of the centrifuge. Centrifugal force causes any bubbles entering the centrifuge to collapse, while the distilland, composing the collapsing bubble films, is spun outward to the drum, where due to gravity and/or drum wall taper angle, it flows upstream along drum walls, and is released through perforations in the bottom drum edge, to splash against and drip down the walls of the bubble-collapsing chamber. The gasses escaping from the confines of collapsing bubbles within the centrifuge join the mist-stripped flow of gases through the centrifuge to vacuum pipe [22]. A continuously running centrifuge will centrifugally scrub mist droplets from distillate and stripping gases as these gases are passing through the centrifuge to the vacuum pipe, so the centrifuge may be run continuously for mist scrubbing purposes. In this case, no sensor system is needed for froth, since the centrifuge is already operating for mist scrubbing purposes at any given moment that upwelling froth enters the centrifuge.

The centrifuge performs its necessary function under all pressure conditions from hard vacuum to ambient. The flow stream of stripping gases, mixed with individual stripped distillate molecules, blobs of froth and particulate, entrained distilland droplets, and distillate mist, emerges from the tumultuous mass of liquid and bubbles in the bubble expansion chamber, and this diverse mixture advances toward the rotating centrifuge. As this mixed flow stream enters the centrifuge, the flow stream partitions [190] within the centrifuge immediately subject the entering flow stream to rotational movement around the drum axis, as it moves into and then progresses downstream within the centrifuge, ultimately toward the vacuum pump. As the flow stream progresses unimpeded along the axis of the centrifuge, there is little resistance from flow stream stripping gases and gas phase stripped molecules, to centrifugal accumulation of all included particles that are not gas phase. Any particulate within this flow stream rapidly accumulates along the inside tapered drum wall, where these liquid and solid particles consolidate and flow upstream, where they will be discharged out of the drum, induced by gravity and the appropriately tapered (angle of taper depending upon many application-specific factors) walls of the drum. Even a drum mounted horizontally, or “upside down”, but with more of a taper, will induce the consolidated distillate to flow “upstream” (opposite the direction of the gas stream flow), for discharge out of the large end of the tapered drum. When the consolidated distillate liquid reaches the larger upstream open end of the drum, the liquid can be discharged through perforations along this upstream edge, or it can simply dribble out this larger end of the drum, to splash against and drip down the walls of the bubble-collapsing chamber. In FIG. 18, the rotation of the flat vertical sheet shown at [190] causes immediate rotation of the gas flow stream within and entering the centrifuge. Some of the distilland particulate will impact against the vertical sheet rotating surfaces, and slide across to the drum wall and join the liquid discharging out the large end of the centrifuge. The remaining particulate will centrifugally migrate to the drum wall and join the liquid flow out of the large drum end. The gas phase flow stream of distillate gases and stripping gases continues to move downstream through the centrifuge unimpeded. Even though caught up within the centrifuge drum's rotation, all gasses continue expanding normally, through the centrifuge, and toward the vacuum pump.

Examining the parts of the example froth and mist centrifuge in FIG. 18, we see a multi-arm support fixture at [184], which is supported at the walls by dropping onto L-shaped pins, so that the attachment can be made CIP compatible. A shaft support pad [185] is seen more clearly in Detail K. The bottom shaft end of centrifuge [183] attaches to fixture [184], according to Detail K, while the top shaft end is secured by alignment fixture [186]. If drum sections are used, rather than an entire drum cylinder, the central shaft rotates horizontal flat strips [187] and [188], which are welded to the two opposing tapered drum sections, as shown at [189]. In the case of using a drum cylinder, the shaft rotates the drum through vertical sheet [190]. Spanning the gap between opposite drum walls, or between both the two trailing edges of the rotating drum sections, is vertical flat sheet [190], which completely spans the gap between both right-angle brackets extending from the trailing edges of the two drum sections (or between opposite sides of the drum wall), and also spans the gap between upper and lower horizontal flat strips [187] and [188] when drum sections are used. We can see from Section J-J, that the rotating centrifuge scoops up any bubbles that may emerge from below, catching the bubbles between horizontal flat strips [187] and [188] (if drum sections are used), and against sheet [190]. As the bubbles are caught in the centrifuge, and pressed against the drum walls or drum sections, or impacted by vertical sheet [190] and spun outward against the drum walls or drum sections [189], the collapsing bubble distilland collects and is slung against the drum or drum sections, to flow upstream along the tapered drum or drum sections, and finally to be expressed out through the perforations at the bottom of the drum or drum sections. Distilland mist and droplets are similarly impelled to rotate with the flowing gas stream by the rotating sheet [190]. Whereas scrubbed gases continue to pass vertically downstream to the vacuum, distilland mist and droplets are centrifugally sifted from the gas stream over to the drum or drum section walls. Centrifugal force causes the accumulated droplets to flow along the sheet and collect against the tapered drum or drum sections, and then flow upstream along the drum wall in the direction impelled by gravity and/or the drum wall taper, to be expressed out the large end of the drum or drum section perforations. The expressed distilland and included particulate spurts out against the adjacent walls of the bubble-collapsing chamber, and drips down the chamber walls into the pool of distilland immediately above the bubble tubes.

Rotational power is transferred to the centrifuge through CIP compatible finger coupling [191] and shaft [192], which are held in place by small alignment fixture [193], which is pin mounted for CIP compatibility. This coupling is used again at [194] on shaft [195], to allow for opening and closing of the tower at this location, with the coupling self-aligning during closing. Shaft [195] is powered by the centrifuge drive motor [196], having a vacuum-tight shaft seal where the shaft enters the chamber. Note in Isometric L and Section M-M views, that when the two coupling halves come together, there are only three bearing points: the tip of the finger, at [197], and along the top of the raised rib, such as at [198], so as to make the coupling CIP compatible. A better view of the two rib bearing-points can be seen in Section M-M view, as [198] and [199].

Detail K consist of: four vertical guides [200] welded to the center of the support fixture [184] and having a support ring at the top; the guides hold a ceramic pad section [201] and the ceramic shaft tip [202] in axial alignment. Shaft tip [202] has stainless shaft [204] bonded into the tip under pressure, so that O-ring [203] forms a seal between [202] and [204]. Note that all components in Detail “K” are designed to be CIP compatible.

Other Uses for the Continuous Flow Centrifuge: It is clear that the open-ended continuous flow centrifuge has many other valuable uses besides scrubbing particulate from commercial and industrial distillation flow streams. A version of this device made of high temperature materials and with isolated or cooled bearings, would be helpful removing particulate from gas flow streams, such as power plant exhaust, for example, or particulate-laden industrial exhaust filtration. This technology could also remove particulate from turbid liquid flow streams, such as industrial wastewater applications and various types of municipal soil run-off flow streams. Currently such treated applications may use various types of filters, which can be costly, and are often troubled with clogging problems.

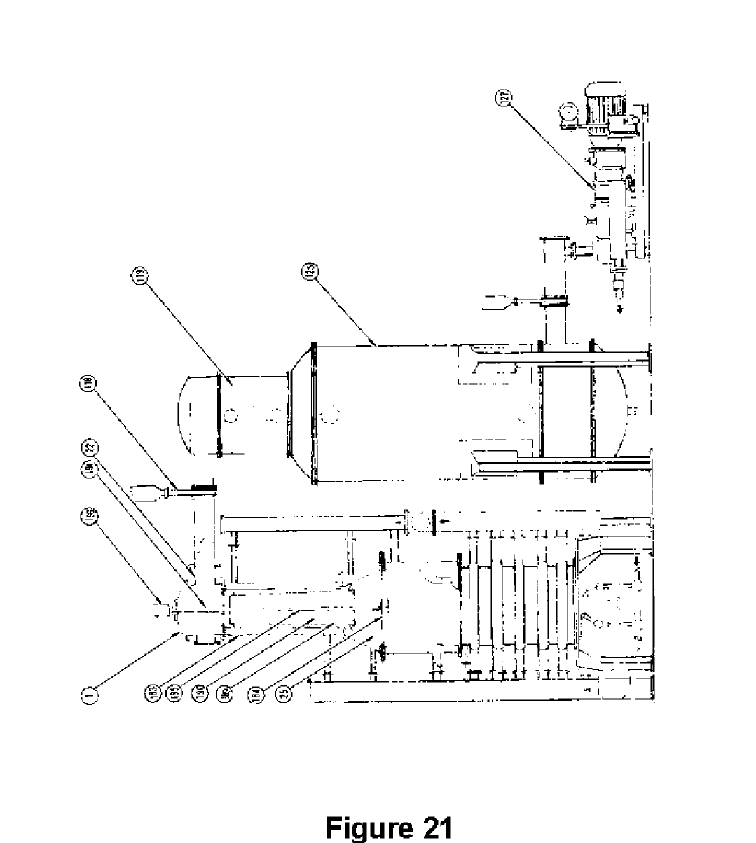

Alternate Equipment Set-Up Example: In FIG. 21 we see the front elevation of an alternate example of the bubble tower and principle associated equipment. The cold bubble stripping tower [1] has a cut-away view of the top of the tower, to show a froth & mist centrifuge inside [183]. The bubble-collapsing chamber [25] contains the multi-arm support fixture [184] supporting the centrifuge shaft [195], which in this example supports the tapered drum [189] with its vertical sheets are shown at [190]. There is only one finger coupling [194] on this shaft, which is powered by drive motor [196]. The flow stream of stripping gas and stripped molecules emerging from the small downstream end of the centrifuge pass into vacuum pipe [22], through gate valve [118], and through heat exchanger [119], which will not be operating unless the temperature of the gas flow stream is low enough to create difficulties condensing the volatiles out of the flow stream. The flow stream then enters condenser [125] where the stripped volatiles are returned to liquid phase and pumped out of the bottom of the condenser. The stripping gas remains in the flow stream, to be drawn through vacuum pump [127] and exhausted, or returned to the bottom of tower [1] for recycled use as stripping gas.

Wine and Vinegar Concentrates: Preliminary efforts with a batch sampler provided some early samples, including wine and balsamic vinegar liquid concentrates without damaging the flavor of the initial products. Dry wine powders exist, but they taste terrible, due to the nearly complete thermal destruction of any flavor that the wine originally possessed. Todd Hunter Co. recently started producing bottled wine reductions as a commercial cooking ingredient, but they use the conventional application of high heat to create these reductions. While these products by Todd Hunter validate the existence of a robust market for wine concentrates, their quality can not be expected to be much better than the thermal wine reductions made in home and restaurant kitchens everywhere.

Others have experimentally produced concentrated balsamic vinegars in a liquid form. Here again, the conventional high temperature concentrate process used destroys most of the flavor. Our prototype tests of the subject cold bubble extraction process repeatedly produces extracts and concentrates of the very highest quality, due to the comparatively gentle bubble treatment and cold temperatures employed. Perhaps the most nuanced and frequently assessed aromas of all food liquids, would be those of wines. With wines, even the subtlest of changes can radically alter quality. Again, our prototype processing of wine concentrates prove that the initial good flavor and aroma are not only retained fully intact, but are intensified multiple times through concentration. It is clear that an aroma extraction process that delicately performs most of the extraction at temperatures near freezing, and never exceeds ambient temperatures, will provide aroma extracts of unprecedented molecule intactness, and therefore of unprecedented aroma, flavor, color, and nutritional value, as demonstrated by our unoptimized wine concentrate tests.

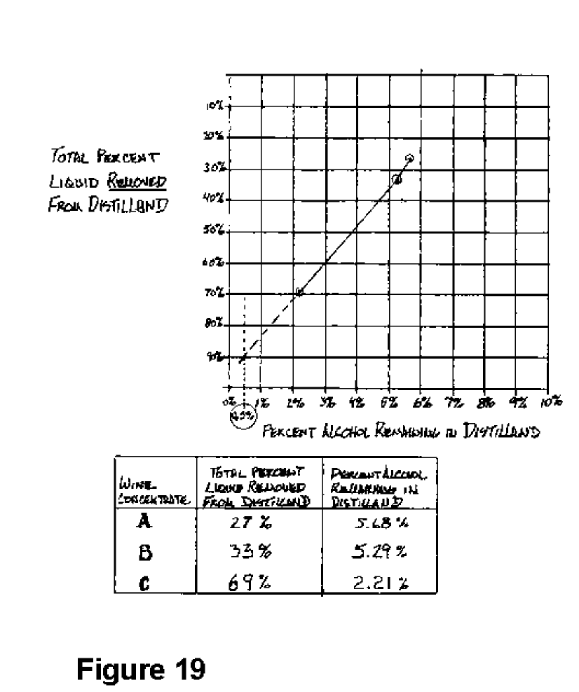

Alcohol Removal from Wine Concentrates: In the process of making a wine concentrate, alcohol is removed along with the water. In “FIG. 19; Wine Concentrate Alcohol Removal”, we see that a limited assessment of alcohol remaining in a few of our prototype wine concentrates has been made. With these prototype samples, no effort was made to preferentially remove more of the alcohol during concentration; alcohol was simply removed along with the water. Three concentrates were tested for alcohol content, shown in the chart as “A”, “B”, and “C”. While this is admittedly limited data, the results clearly indicate that under these conditions, alcohol removal from about 30% to 70% reduction of total liquid is linear. The slight deviation from precise linearity is understandable, when we remember that these are three different wines, and they each started the concentrate process with different percentages of alcohol. We could not expect them all to end up at the same point on the line for any given level of concentration, especially at lesser concentration levels. If we extrapolate the results by projecting the alcohol content slope, we can see where to expect alcohol content to fall below the “alcohol free” limit of 0.5%, as defined by the FDA. This point is reached at about the 90% mark, where 90% of the combined water plus alcohol has been removed. This is provided we make no special effort to remove proportionally more alcohol, early in the process. As with any new application, the exact percentage of concentration would need to be determined experimentally.

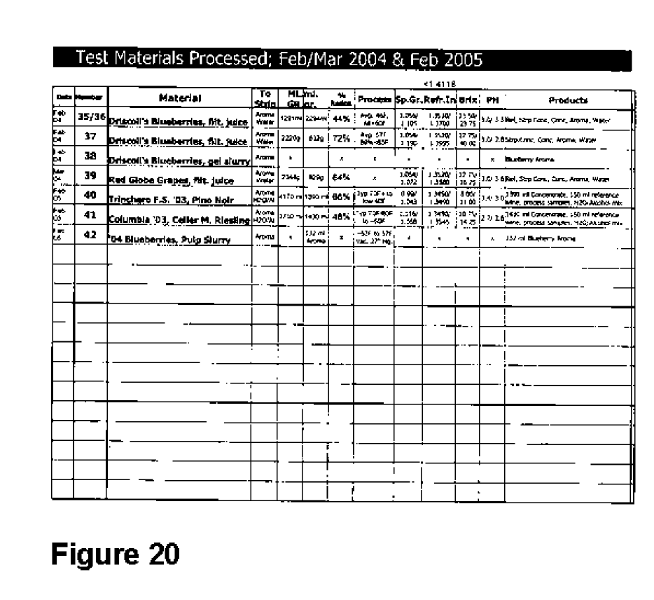

Fruit Juice Concentrates: In addition to several different kinds of wine concentrates, some juice concentrates have also been experimentally produced. Turning to “FIG. 20: Material Processed in Prototypes 2A & 2B”, we see in material #37 that blueberry juice has been concentrated to a 72% reduction of the starting volume. When the aroma distillate, also containing some water, is put back in the concentrate, we get a lower finished concentration. The flavor and nutrition is essentially unchanged from that of the fresh juice. Since the water distillate removed from the juice was taken out cold, there are no burned essence notes common with the waste steam discarded by conventional processes. This fact allows us to collect rather than discard this water, and we can now add to this water, the essence extracted from material #38. This water now constitutes an unprecedented new product: bottled water and flavor that has been entirely extracted from the fresh fruit, and having the full flavor of the fresh fruit. This water now becomes a second high-value product stream, supplementing the full-flavor and full-nutrition fruit juice concentrate product.

Pathogens: Since the Cold Bubble process operates at such low temperatures, pathogen kill does not automatically occur as a consequence of processing, such as it does with conventional concentration methods such as fruit juice concentrates. Consequently, surface treatments will be used, and sterile conditions during processing and packaging are required. High Pressure Processing (HPP or UHPP) can certainly be used, but costs for this equipment will be high, so surface treatment methods will probably always be preferred. All food products processed in a cold bubble tower will fall into three different pathogen-relevant categories:

A. Pathogen-free Precursors: Of course, some products will come to this process in a pathogen-free condition, such as balsamic vinegars, wines, or any other alcoholic drinks. If processing and packaging are conducted in accordance with conventional sanitary conditions, the concentrate products of pathogen-free starting materials will also be pathogen free.

B. Distillate Products: When Cold Bubble process is used to produce any kind of distillate such as botanical extracts, these distillates are of course pathogen-free, and only need to be processed, handled, and packaged under conventional sanitary conditions to maintain their purity. All extracted products; such as flavor and aroma extracts are also of this type, as are specialty chemical separations.

C. Juice Concentrates: Any kind of fruit or vegetable concentrates can be cold-bubble processed and packaged in plastic film containers, and then subjected to High Pressure Processing (HPP), for complete cold processed full flavor quality and purity. While HPP is an excellent method for pathogen kill, it is still a relatively new and expensive process. A low cost method for dealing with pathogens is by using known surface treatments, such as is used with some fresh squeezed apple juice products. With apple juice, the apples are washed conventionally, and then put in boiling water for a very short time, and then into cold water, just prior to juice extraction. This is a low thermal impact method that takes advantage of the purity of intact fruit, by killing any pathogens on the outside of the apple skins of intact fruit. This brief boiling water immersion method could also be used with many other fruit types having robust contiguous skins, such as oranges and other citrus, apricots, peaches, plums, all melons, pomegranates, and etc. Many vegetables having robust skins are also good contenders for surface treatment methods of pathogen kill.

1. An apparatus operable for separating a volatile liquid from a solution comprising said volatile liquid, said solution being maintained at a temperature that is greater than the freezing temperature of said solution and less than the boiling temperature of said solution, the apparatus comprising:
a) At least one vertical bubble tube having an open upper end having solution injection means in fluid communication therewith, said solution injection means being operable for introducing said solution into said bubble tube, and a lower end in opposition to said upper end;
b) Gas injection means disposed at said lower end operable for introducing a gas into said lower end of said bubble tube, said gas operable for forming bubbles which rise through said bubble tube to collect and transport a vapor phase of said volatile liquid into said upper end;
c) Vacuum means operable for maintaining a reduced pressure above said open end of said bubble tube;
d) A froth and mist arrestor disposed downstream from said upper end operable for enabling only said vapor phase of said volatile liquid to pass therethrough;
e) Vapor collection means disposed downstream from said froth and mist arrestor operable for collecting said vapor phase that passes through said froth and mist arrestor; and
f) A flow stream of molecules comprising said vapor phase of said volatile liquid, wherein said molecules have a range of masses, and wherein said flow stream defines a path through the apparatus originating at said lower end of said bubble tube, passing through said froth and mist arrestor and terminating at said vapor collection means.

2. An apparatus as in claim 1 wherein said bubble tubes have an interior surface and a substantially cylindrical interior volume, said flow stream of said bubbles through said interior volume being characterized by an average path length and an average travel time, and wherein said interior surface has a plurality of protrusions projecting inwardly therefrom operable for increasing said average path length and said average travel time of said bubbles within said bubble tube.

3. An apparatus as in claim 1 wherein said means for maintaining said apparatus under partial vacuum is a vacuum pump.

4. An apparatus as in claim 1 wherein said froth and mist arrestor comprises a rotating assembly housed within a substantially cylindrical enclosure, said rotating assembly comprising an axle aligned with the axis of said cylindrical enclosure and parallel to the direction of said flow stream, and one or more flat surfaces affixed to said axle, wherein said one or more flat surfaces have a face and a rotational velocity that is orthogonal to said flow stream and is operable for creating a cyclonic air flow, wherein cyclonic air flow is filters said range of masses of said molecules in said air flow through the centripetal force of rotational motion.

5. An apparatus as in claim 2 wherein said froth and mist arrestor comprises a rotating assembly housed within a substantially cylindrical enclosure, said rotating assembly comprising an axle aligned with the axis of said cylindrical enclosure and parallel to the direction of said flow stream, and one or more flat surfaces affixed to said axle, wherein said one or more flat surfaces have a face and a rotational velocity that is orthogonal to said flow stream and is operable for creating a cyclonic air flow, wherein cyclonic air flow is filters said range of masses of said molecules in said air flow through the centripetal force of rotational motion.

6. An apparatus as in claim 1 wherein said vapor collection means comprises a condensation surface obstructing said flow stream and releasing means operable for causing the release of said volatile compounds from said condensation surface, and a secondary collection means operable for the subsequent collection of said volatile compounds released from said condensation surface.

7. An apparatus as in claim 6 wherein said releasing means comprises heating the condensation surface to a temperature above the melting point of said volatile compounds such that said volatile compounds become dislodged from said condensation surface and subsequently fall under the force of gravity.

8. An apparatus as in claim 6 wherein said secondary collection means comprises a collection vessel placed directly underneath said falling volatile compounds.

9. A method for separating a volatile liquid from a solution comprising said volatile liquid, said solution being maintained at a temperature that is greater than the freezing temperature of said solution and less than the boiling temperature of said solution, the method comprising:
a. Presenting an apparatus in accordance with claim 1,
b. Injecting said solution into said open end of said at least one vertical bubble tube,
c. Injecting a gas into said lower open end of said at least one vertical bubble tube, said gas forming bubbles which rise through said bubble tube in a direction defining a flow stream to collect and transport a vapor phase of said volatile liquid to said upper end;
d. Maintaining a reduced pressure above said open end of said bubble tube;
e. Filtering said vapor phase of said volatile liquid using said froth and mist arrestor at said upper end of said bubble tube; and
f. Collecting said vapor phase downstream from said froth and mist arrestor.

10. A method as in claim 9 including the step of mechanically constraining said flow stream to follow a tortuous path through said bubble tubes.

11. A Method as in claim 9 including the step of using a standard roughing pump for maintaining said reduced pressure above said open end of said bubble tube.

12. A Method as in claim 9 wherein said step of filtering said vapor phase of said volatile liquid includes presenting said flow stream to one or more rotating arms that deflect particulate matter in a direction orthogonal to said flow stream while leaving said vapor phase of said flow stream substantially undeflected.

13. A Method as in claim 9 including the step of presenting said flow stream to said vapor collection means.

14. A method of removing selected volatile components from a solute, said method comprising:
a. Maintaining said solute at a temperature wherein said temperature is above the freezing point of both said selected volatile components and said solute,
b. Applying a vacuum to provide a pressure to the surface of said solute, wherein said pressure is less than the vapor pressure of said selected volatile components but greater than the vapor pressure of said solute such that said selected volatile components evaporate,
c. introducing a non-reactive gas within said solute to expedite evaporation of said selected volatile components and,
d. Collecting said solute following the evaporation of said selected volatile components.

15. A method of extracting selected volatile components from a solute, said method comprising:
a. Maintaining a temperature within said solute wherein said temperature is above the freezing point of both said selected volatile components and said solute,
b. Applying a vacuum to provide a pressure to the surface of said solute, wherein said pressure is less that the vapor pressure of said selected volatile components but greater than the vapor pressure of said solute such that said selected volatile components evaporate to form an evaporative stream,
c. Introducing a non-reactive gas within said solute to expedite evaporation of said selected volatile components,
d. Introducing a cold surface within said evaporative stream of said selected volatile components, wherein said cold surface has a temperature less than or equal to the freezing point of said selected volatile components such that said selected volatile components condense on said cold surface,
e. Applying a small amount of heat to said cold surface after said selected volatile components have condensed thereon, wherein said heat is sufficient to dislodge the condensed selected volatile components from said cold surface, and
f. Collecting the dislodged selected volatile components.

16. A method of extracting selected volatile components from a solute, said method comprising:
a. Maintaining a temperature within said solute wherein said temperature is above the freezing point of both said selected volatile components and said solute,
b. Applying a vacuum to provide a pressure to the surface of said solute, wherein said pressure is less that the vapor pressure of said selected volatile components but greater than the vapor pressure of said solute such that said selected volatile components evaporate to form an evaporative stream,
c. Introducing a non-reactive gas within said solute to expedite evaporation of said selected volatile components,
d. Introducing conventional condensation apparatus within said evaporative stream of said selected volatile components such that said selected volatile components condense thereon, and
e. Collecting the condensed selected volatile components.
